(19) United States
(12) Patent Application Publication
(10) Pub. No.: US 2024/0064129 A1
(43) Pub. Date: Feb. 22, 2024

(54) A Method and Function for Accessing a Non-Public Network

(71) Applicant: Telefonaktiebolaget LM Ericsson (publ), Stockholm (SE)

(72) Inventors: Noamen Ben Henda, Vällingby (SE); Henrik Normann, Malmö (SE); Helena Vahidi Mazinani, Lund (SE); Miguel Angel Garcia Martin, Pozuelo de Alarcon (Madrid) (ES)

(21) Appl. No.: 18/259,416

(22) PCT Filed: Dec. 20, 2021
(86) PCT No.: PCT/EP2021/086902

§ 371 Date: Jun. 27, 2023

Related U.S. Application Data
(60) Provisional application No. 63/131,936, filed on Dec. 30, 2020.

(51) Int. Cl. H04L 9/40; H04L 9/32; H04L 9/08

(52) U.S. Cl. CPC H04L 63/0428; H04L 9/3242; H04L 9/0816

(57) ABSTRACT

Embodiments include methods for a user equipment, UE (510, 1010, 1100), to obtain security credentials for accessing a non-public network, NPN. Such methods include performing (610) a primary authentication procedure to, obtain a key K_{AUSF} for secure communication between the UE and an onboarding network ON. Such methods also include receiving (620), from a unified data management, UDM, function, encrypted UE credentials for accessing the NPN, and decrypting (630) the encrypted UE credentials based on K_{AUSF}. Other embodiments include complementary methods for UDM functions, authentication server functions (AUSF), and NPN provisioning servers, PVS, as well as UEs or network nodes configured to perform the exemplary methods.

### TECHNICAL FIELD

The present application relates generally to the field of communication networks, and more specifically to obtain, or to facilitate obtaining, security credentials (e.g., encryption keys) for accessing a non-public network, NPN, by a user equipment, UE.

### INTRODUCTION

Currently the fifth generation (“5G”) of cellular systems, also referred to as New Radio (NR), is being standardized within the Third-Generation Partnership Project (3GPP). NR is developed for maximum flexibility to support multiple and substantially different use cases. Besides the typical mobile broadband use case, also machine type communication (MTC), ultra-low latency critical communications (URLCC), side-link device-to-device (D2D), and several other use cases.

3GPP security working group SA3 specified the security-related features for Release 15 (Rel-15) of the 5G System (5GS) in 3GPP TS 33.501 (v15.10.0). In particular, the 5GS includes many new features (e.g., as compared to earlier 4G/LTE systems) that required introduction of new security mechanisms. For example, 5GS seamlessly integrates non-3GPP access (e.g., via wireless LAN) together with 3GPP access (e.g., NR and/or LTE). As such, in 5GS, a user equipment (UE, e.g., wireless device) can access services independent of underlying radio access technology (RAT).

3GPP Rel-16 also specifies support for Non-Public Networks (NPN) that are for non-public use, as described in 3GPP TS 23.501 (v16.6.0). An example NPN is a factory or other industrial facility that deploys its own 5GS to provide connectivity for both equipment and workers. NPNs can be deployed as a Stand-alone Non-Public Network (SNPN) when not relying on network functions provided by a public land mobile network (PLMN). An SNPN is identified by a PLMN ID and (network ID) NID broadcast in system information block 1 (SIB1).

An SNPN-capable UE supports the SNPN access mode. When the UE is set to operate in SNPN access mode, the UE only selects and registers with SNPNs. When the UE is not set to operate in SNPN access mode, the UE performs normal PLMN selection procedures. UEs operating in SNPN access mode only (re)select cells within the selected/registered SNPN and a cell can only be considered as suitable when the PLMN and NID broadcast by the cell matches the selected/registered SNPN.

Alternately, NPNs can be deployed as a Public Network Integrated (PNI) NPN when relying on functions provided by a PLMN. For PNI-NPNs, Closed Access Groups (CAGs) identify groups of subscribers who are permitted to access one or more cells associated with the CAG. A CAG is identified by a CAG identifier broadcast in SIB1. A CAG-capable UE can be configured with the following per PLMN:
Allowed CAG list containing the CAG identifiers that the UE is allowed to access; and
CAG-only indication if the UE is only allowed to access 5GS via CAG cells.
   The UE checks the suitability of CAG cells based on the Allowed CAG list provided by upper layers. When the UE is configured with a CAG-only indication, only CAG Member Cells can be suitable. A non-suitable cell can be acceptable though if the UE is configured with a CAG-only indication for one of the PLMN broadcast by the cell.

The Rel-16 enhancements specified for SNPNs include updates to the primary authentication procedures used by UEs. 3GPP is also working on further enhancements to NPN for Rel-17. One of the objectives of the Rel-17 work is enhanced authentication procedures that facilitate UE authentication by an external entity to the SNPN. Another objective is onboarding and provisioning of credentials to UEs that do not have an established relationship with an NPN. These UE credentials are sensitive information that must be kept hidden from any unauthorized entities. For example, if the credentials fall in the wrong hands, they can be used to impersonate the UE and gain access to restricted services.

### SUMMARY

However, current provisioning techniques do not adequately protect UE credentials during delivery from the provisioning entity to the UE.

Accordingly, embodiments of the present disclosure address these and other problems, issues, and/or difficulties that can occur when a UE attempts to access an NPN, thereby enabling the otherwise-advantageous deployment of NPNs based on 5GS.

Some embodiments of the present disclosure include methods (e.g., procedures) to obtain security credentials for accessing an NPN. The security credentials are for accessing the NPN by a UE. These exemplary methods can be performed by a UE (e.g., wireless device).

These exemplary methods can include performing a primary authentication procedure to obtain a key K_{AUSF} for secure communication between the UE and an onboarding network (ON). These exemplary methods can also include receiving, from a unified data management function (UDM), encrypted UE credentials for accessing the NPN. These exemplary methods can also include decrypting the encrypted UE credentials based on K_{AUSF}. In some embodiments, these exemplary methods can also include obtaining access to the NPN based on the decrypted UE credentials.

In some embodiments one of the following cryptographic algorithms or functions is used to decrypt the encrypted UE credentials: a hash message authentication code (HMAC) function; or a cryptographic algorithm used for protection of UE Parameter Update (UPU) procedure payloads. In some embodiments, one of the following keys can be used to decrypt the UE credentials: K_{AUSF}; or a key derived from K_{AUSF} based on a Generic Bootstrapping Architecture (GBA) Key Derivation Function (KDF) and a specific FC value allocated for UPU key derivation.

In some embodiments, the encrypted UE credentials can be received in control plane (CP) non-access stratum (NAS) signaling from an access and mobility management function (AMF) associated with the NPN. In some embodiments, the UDM can be part of a provisioning server (PVS) for the NPN. In some embodiments, the primary authentication can be based on default UE credentials.

Other embodiments include methods (e.g., procedures) to facilitate UE access to an NPN. These exemplary methods can be performed by an authentication server function (AUSF).

These exemplary methods can include performing a primary authentication procedure to obtain a key K_{AUSF} for secure communication between the UE and an ON. These exemplary methods can also include receiving, from a UDM function, unencrypted UE credentials for the UE to access the NPN. These exemplary methods can also include encrypting the UE credentials based on K_{AUSF} and sending the encrypted UE credentials to the UDM.

In some embodiments, one of the following cryptographic algorithms or functions can be used to encrypt the UE credentials: an HMAC function; or a cryptographic algorithm used for protection of UPU procedure payloads. In some embodiments, one of the following keys can be used to encrypt the UE credentials: K_{AUSF}; or a key derived from K_{AUSF} based on a GBA KDF and a specific FC value allocated for UPU key derivation.

In some embodiments, a trust relationship can exist between the AUSF and a PVS for the NPN before receiving the unencrypted UE credentials. This can be the case, for example, when the AUSF is part of the ON. In some embodiments, the primary authentication can be based on default UE credentials obtained by the AUSF from a default credential server (DCS).

Other embodiments include additional methods (e.g., procedures) to facilitate UE access to an NPN. These exemplary methods can be performed by a UDM function.

These exemplary methods can include obtaining encrypted UE credentials for the UE to access the NPN, from one of the following: a PVS for the NPN, or from an AUSF. These exemplary methods can also include sending the encrypted UE credentials to the UE.

In some embodiments, the obtaining operations can include sending unencrypted UE credentials to the AUSF and receiving the encrypted UE credentials from the AUSF. In some of these embodiments, the obtaining operations can also include receiving the unencrypted UE credentials from a PVS for the NPN. In such embodiments, a trust relationship can exist between the UDM and the PVS before receiving the unencrypted UE credentials. This can be the case, for example, when the UDM is part of the ON.

In some embodiments, the encrypted UE credentials are encrypted based on one of the following cryptographic algorithms or functions: an HMAC function; or a cryptographic algorithm used for protection of UPU procedure payloads. In some embodiments, the encrypted UE credentials are encrypted based on one of the following keys: K_{AUSF}; or a key derived from K_{AUSF} based on a GBA KDF and a specific FC value allocated for UPU key derivation.

Other embodiments include additional methods (e.g., procedures) to facilitate UE access to an NPN. These exemplary methods can be performed by a PVS for the NPN.

These exemplary methods can include generating or obtaining unencrypted UE credentials for the UE to access the NPN. These exemplary methods can also include obtaining encrypted UE credentials based on the unencrypted UE credentials. These exemplary methods can also include sending the encrypted UE credentials to the UE.

In some embodiments, the obtaining operations can include sending the unencrypted UE credentials to an AUSF and receiving the encrypted UE credentials from the AUSF. In such embodiments, a trust relationship can exist between the AUSF and the PVS before sending the unencrypted UE credentials.

In some of these embodiments, the encrypted UE credentials are encrypted (e.g., by AUSF) based on one of the following keys: K_{AUSF}; or a key derived from K_{AUSF} based on a GBA KDF and on a specific FC value allocated for UPU key derivation. In some of these embodiments, the encrypted UE credentials can be sent to the UE via an AMF associated with the NPN.

In other embodiments, the obtaining operations can include receiving, from an AUSF of an ON, a key (K_{PVS}) derived from a key (K_{AUSF}) used for secure communication between the UE and the ON; and encrypting the unencrypted UE credentials using the derived key (K_{PVS}). In such embodiments, the encrypted UE credentials can be sent to the UE via a UDM and an AMF, both associated with the NPN.

In some embodiments, the encrypted UE credentials are encrypted (e.g., by PVS or AUSF) based on one of the following cryptographic algorithms or functions: an HMAC function; or a cryptographic algorithm used for protection of UPU procedure payloads.

Other embodiments include UEs, AUSFs, UDMs, or PVS's (or network nodes hosting the same) that are configured to perform the operations corresponding to any of the exemplary methods described herein. Other embodiments include non-transitory, computer-readable media storing computer-executable instructions that, when executed by processing circuitry, configure such UEs, AUSFs, UDMs, or PVS's to perform operations corresponding to any of the exemplary methods described herein.

These and other embodiments described herein can provide confidentiality protection for a UPU procedure between a UDM in the UE's home PLMN to the UE. Furthermore, embodiments do not require a negotiation procedure to establish the security parameters required for encryption. Also, embodiments do not incur signaling overhead towards the UE and can be used independently of whether the UE includes a universal integrated circuit card (UICC, also known as a SIM).

These and other objects, features, and advantages of the present disclosure will become apparent upon reading the following Detailed Description in view of the Drawings briefly described below.

### BRIEF DESCRIPTION OF THE DRAWINGS

FIGS. 1-2 illustrate various aspects of an exemplary 5G network architecture.

FIG. 3 shows an exemplary hierarchy of security keys in a 5G network.

FIG. 4 shows a high-level view of a security key hierarchy that excludes keys from outside an extensible authentication protocol (EAP) realm.

FIG. 5 shows a signal flow diagram of an exemplary procedure for provisioning NPN credentials to a UE, according to various embodiments of the present disclosure.

FIG. 6 illustrates an exemplary method (e.g., procedure) for a UE, according to various embodiments of the present disclosure.

FIG. 7 illustrates an exemplary method (e.g., procedure) for an AUSF, according to various embodiments of the present disclosure.

FIG. 8 illustrates an exemplary method (e.g., procedure) for a UDM function, according to various embodiments of the present disclosure.

FIG. 9 illustrates an exemplary method (e.g., procedure) for a PVS, according to various embodiments of the present disclosure.

FIG. 10 illustrates a wireless network, according to various embodiments of the present disclosure.

FIG. 11 shows an embodiment of a UE, in accordance with various aspects described herein.

FIG. 12 is a block diagram illustrating an exemplary virtualization environment usable for implementation of various embodiments of network nodes or NFs described herein.

FIGS. 13-14 are block diagrams of various exemplary communication systems and/or networks, according to various embodiments of the present disclosure.

FIGS. 15-18 are flow diagrams of exemplary methods (e.g., procedures) for transmission and/or reception of user data, according to various embodiments of the present disclosure.

### DETAILED DESCRIPTION

Embodiments briefly summarized above will now be described more fully with reference to the accompanying drawings. These descriptions are provided by way of example to explain the subject matter to those skilled in the art and should not be construed as limiting the scope of the subject matter to only the embodiments described herein. More specifically, examples are provided below that illustrate the operation of various embodiments according to the advantages discussed above.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods and/or procedures disclosed herein do not have to be performed in the exact order disclosed, unless a step is explicitly described as following or preceding another step and/or where it is implicit that a step must follow or precede another step. Any feature of any of the embodiments disclosed herein can be applied to any other embodiment, wherever appropriate. Likewise, any advantage of any of the embodiments can apply to any other embodiments, and vice versa. Other objects, features and advantages of the disclosed embodiments will be apparent from the following description.

Furthermore, the following terms are used throughout the description given below:
Radio Access Node: As used herein, a “radio access node” (or equivalently “radio network node,” “radio access network node,” or “RAN node”) can be any node in a radio access network (RAN) of a cellular communications network that operates to wirelessly transmit and/or receive signals. Some examples of a radio access node include, but are not limited to, a base station (e.g., a New Radio (NR) base station (gNB) in a 3GPP Fifth Generation (5G) NR network or an enhanced or evolved Node B (eNB) in a 3GPP LTE network), base station distributed components (e.g., CU and DU), a high-power or macro base station, a low-power base station (e.g., micro, pico, femto, or home base station, or the like), an integrated access backhaul (IAB) node (or component thereof such as MT or DU), a transmission point, a remote radio unit (RRU or RRH), and a relay node.
Core Network Node: As used herein, a “core network node” is any type of node in a core network. Some examples of a core network node include, e.g., a Mobility Management Entity (MME), a serving gateway (SGW), a Packet Data Network Gateway (P-GW), etc. A core network node can also be a node that implements a particular core network function (NF), such as an access and mobility management function (AMF), a session management function (AMF), a user plane function (UPF), a Service Capability Exposure Function (SCEF), or the like.
Wireless Device: As used herein, a “wireless device” (or “WD” for short) is any type of device that has access to (i.e., is served by) a cellular communications network by communicate wirelessly with network nodes and/or other wireless devices. Communicating wirelessly can involve transmitting and/or receiving wireless signals using electromagnetic waves, radio waves, infrared waves, and/or other types of signals suitable for conveying information through air. Unless otherwise noted, the term “wireless device” is used interchangeably herein with “user equipment” (or “UE” for short). Some examples of a wireless device include, but are not limited to, smart phones, mobile phones, cell phones, voice over IP (VoIP) phones, wireless local loop phones, desktop computers, personal digital assistants (PDAs), wireless cameras, gaming consoles or devices, music storage devices, playback appliances, wearable devices, wireless endpoints, mobile stations, tablets, laptops, laptop-embedded equipment (LEE), laptop-mounted equipment (LME), smart devices, wireless customer-premise equipment (CPE), mobile-type communication (MTC) devices, Internet-of-Things (IoT) devices, vehicle-mounted wireless terminal devices, mobile terminals (MTs), etc.
Radio Node: As used herein, a “radio node” can be either a “radio access node” (or equivalent term) or a “wireless device.”
Network Node: As used herein, a “network node” is any node that is either part of the radio access network (e.g., a radio access node or equivalent term) or of the core network (e.g., a core network node discussed above) of a cellular communications network. Functionally, a network node is equipment capable, configured, arranged, and/or operable to communicate directly or indirectly with a wireless device and/or with other network nodes or equipment in the cellular communications network, to enable and/or provide wireless access to the wireless device, and/or to perform other functions (e.g., administration) in the cellular communications network.
Node: As used herein, the term “node” (without any prefix) can be any type of node that is capable of operating in or with a wireless network (including a RAN and/or a core network), including a radio access node (or equivalent term), core network node, or wireless device.
Service: As used herein, the term “service” refers generally to a set of data, associated with one or more applications, that is to be transferred via a network with certain specific delivery requirements that need to be fulfilled in order to make the applications successful.
Component: As used herein, the term “component” refers generally to any component needed for the delivery of a service. Examples of component are RANs (e.g., E-UTRAN, NG-RAN, or portions thereof such as eNBs, gNBs, base stations (BS), etc.), CNs (e.g., EPC, 5GC, or portions thereof, including all type of links between RAN and CN entities), and cloud infrastructure with related resources such as computation, storage. In general, each component can have a “manager”, which is an entity that can collect historical information about utilization of resources as well as provide information about the current and the predicted future availability of resources associated with that component (e.g., a RAN manager).

Note that the description given herein focuses on a 3GPP cellular communications system and, as such, 3GPP terminology or terminology similar to 3GPP terminology is generally used. However, the concepts disclosed herein are not limited to a 3GPP system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from the concepts, principles, and/or embodiments described herein.

In addition, functions and/or operations described herein as being performed by a wireless device or a network node may be distributed over a plurality of wireless devices and/or network nodes. Furthermore, although the term “cell” is used herein, it should be understood that (particularly with respect to 5G NR) beams may be used instead of cells and, as such, concepts described herein apply equally to both cells and beams.

At a high level, the 5G System (5GS) consists of an Access Network (AN) and a Core Network (CN). The AN provides UEs connectivity to the CN and may include a radio access network (RAN) such as described in more detail below. The CN includes a variety of Network Functions (NF) that provide a range of functionalities such as session management, connection management, charging, authentication, subscription data management, etc.

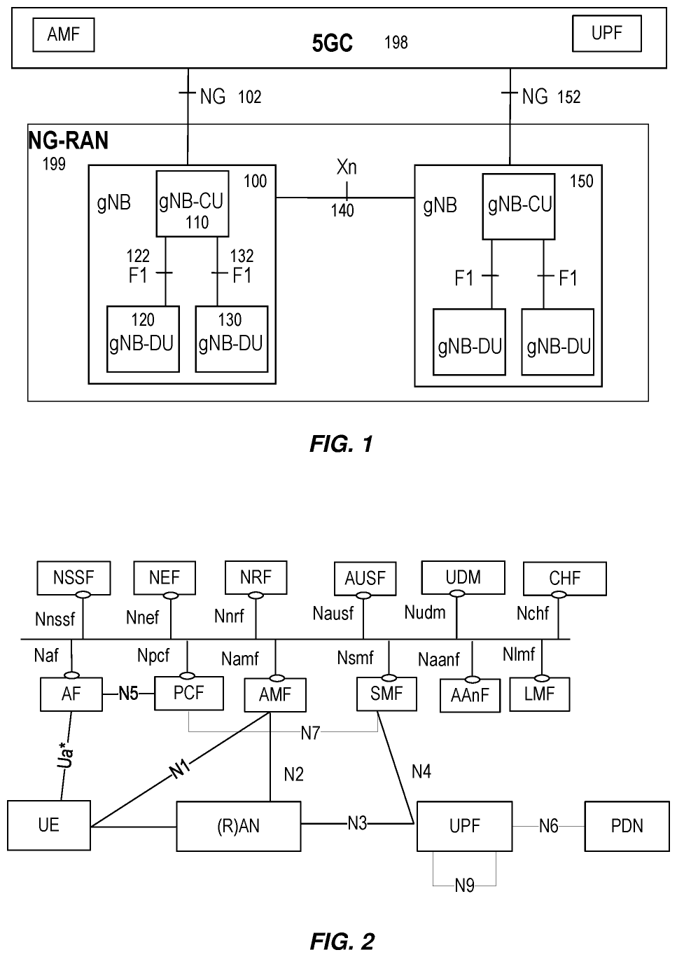

FIG. 1 illustrates a high-level view of an exemplary 5G network architecture, consisting of a Next Generation RAN (NG-RAN) 199 and a 5G Core (5GC) 198. NG-RAN 199 can include one or more gNodeB's (gNBs) connected to the 5GC via one or more NG interfaces, such as gNBs 100, 150 connected via interfaces 102, 152, respectively. More specifically, gNBs 100, 150 can be connected to one or more Access and Mobility Management Functions (AMFs) in the 5GC 198 via respective NG-C interfaces. Similarly, gNBs 100, 150 can be connected to one or more User Plane Functions (UPFs) in 5GC 198 via respective NG-U interfaces. Various other network functions (NFs) can be included in the 5GC 198, as described in more detail below.

In addition, the gNBs can be connected to each other via one or more Xn interfaces, such as Xn interface 140 between gNBs 100 and 150. The radio technology for the NG-RAN is often referred to as “New Radio” (NR). With respect the NR interface to UEs, each of the gNBs can support frequency division duplexing (FDD), time division duplexing (TDD), or a combination thereof. Each of the gNBs can serve a geographic coverage area including one or more cells and, in some cases, can also use various directional beams to provide coverage in the respective cells.

NG-RAN 199 is layered into a Radio Network Layer (RNL) and a Transport Network Layer (TNL). The NG-RAN architecture, i.e., the NG-RAN logical nodes and interfaces between them, is defined as part of the RNL. For each NG-RAN interface (NG, Xn, F1) the related TNL protocol and the functionality are specified. The TNL provides services for user plane transport and signaling transport. In some exemplary configurations, each gNB is connected to all 5GC nodes within an “AMF Region” with the term “AMF” being described in more detail below.

The NG RAN logical nodes shown in FIG. 1 include a Central Unit (CU or gNB-CU) and one or more Distributed Units (DU or gNB-DU). For example, gNB 100 includes gNB-CU 110 and gNB-DUs 120 and 130. CUs (e.g., gNB-CU 110) are logical nodes that host higher-layer protocols and perform various gNB functions such controlling the operation of DUs. A DU (e.g., gNB-DUs 120, 130) is a decentralized logical node that hosts lower layer protocols and can include, depending on the functional split option, various subsets of the gNB functions. As such, each of the CUs and DUs can include various circuitry needed to perform their respective functions, including processing circuitry, transceiver circuitry (e.g., for communication), and power supply circuitry.

A gNB-CU connects to one or more gNB-DUs over respective F1 logical interfaces, such as interfaces 122 and 132 shown in FIG. 1. However, a gNB-DU can be connected to only a single gNB-CU. The gNB-CU and connected gNB-DU(s) are only visible to other gNBs and the 5GC as a gNB. In other words, the F1 interface is not visible beyond gNB-CU.

Another change in 5GS (e.g., in 5GC) is that traditional peer-to-peer interfaces and protocols found in earlier-generation networks are modified and/or replaced by a Service Based Architecture (SBA) in which Network Functions (NFs) provide one or more services to one or more service consumers. This can be done, for example, by Hyper Text Transfer Protocol/Representational State Transfer (HTTP/REST) application programming interfaces (APIs). In general, the various services are self-contained functionalities that can be changed and modified in an isolated manner without affecting other services. This SBA model also adopts principles like modularity, reusability, and self-containment of NFs, which can enable deployments to take advantage of the latest virtualization and software technologies.

The services in 5GC can be stateless, such that the business logic and data context are separated. For example, the services can store their context externally in a proprietary database. This can facilitate various cloud infrastructure features like auto-scaling or auto-healing. Furthermore, 5GC services can be composed of various “service operations”, which are more granular divisions of overall service functionality. The interactions between service consumers and producers can be of the type “request/response” or “subscribe/notify”.

FIG. 2 shows an exemplary non-roaming 5G reference architecture with service-based interfaces and various 3GPP-defined NFs within the Control Plane (CP). These include the following NFs, with additional details provided for those most relevant to the present disclosure:
Application Function (AF, with Naf interface) interacts with the 5GC to provision information to the network operator and to subscribe to certain events happening in operator's network. An AF offers applications for which service is delivered in a different layer (i.e., transport layer) than the one in which the service has been requested (i.e., signaling layer), the control of flow resources according to what has been negotiated with the network. An AF communicates dynamic session information to PCF (via N5 interface), including description of media to be delivered by transport layer.
Policy Control Function (PCF, with Npcf interface) supports unified policy framework to govern the network behavior, via providing PCC rules (e.g., on the treatment of each service data flow that is under PCC control) to the SMF via the N7 reference point. PCF provides policy control decisions and flow based charging control, including service data flow detection, gating, QoS, and flow-based charging (except credit management) towards the SMF. The PCF receives session and media related information from the AF and informs the AF of traffic (or user) plane events.
User Plane Function (UPF)—supports handling of user plane traffic based on the rules received from SMF, including packet inspection and different enforcement actions (e.g., event detection and reporting). UPFs communicate with the RAN (e.g., NG-RNA) via the N3 reference point, with SMFs (discussed below) via the N4 reference point, and with an external packet data network (PDN) via the N6 reference point. The N9 reference point is for communication between two UPFs.
Session Management Function (SMF, with Nsmf interface) interacts with the decoupled traffic (or user) plane, including creating, updating, and removing Protocol Data Unit (PDU) sessions and managing session context with the User Plane Function (UPF), e.g., for event reporting. For example, SMF performs data flow detection (based on filter definitions included in PCC rules), online and offline charging interactions, and policy enforcement.
Charging Function (CHF, with Nchf interface) is responsible for converged online charging and offline charging functionalities. It provides quota management (for online charging), re-authorization triggers, rating conditions, etc. and is notified about usage reports from the SMF. Quota management involves granting a specific number of units (e.g., bytes, seconds) for a service. CHF also interacts with billing systems.
Access and Mobility Management Function (AMF, with Namf interface) terminates the RAN CP interface and handles all mobility and connection management of UEs (similar to MME in EPC). AMFs communicate with UEs via the N1 reference point and with the RAN (e.g., NG-RAN) via the N2 reference point.
Network Exposure Function (NEF) with Nnef interface—acts as the entry point into operator's network, by securely exposing to AFs the network capabilities and events provided by 3GPP NFs and by providing ways for the AF to securely provide information to 3GPP network. For example, NEF provides a service that allows an AF to provision specific subscription data (e.g., expected UE behavior) for various UEs.
Network Repository Function (NRF) with Nnrf interface—provides service registration and discovery, enabling NFs to identify appropriate services available from other NFs.
Network Slice Selection Function (NSSF) with Nnssf interface—a “network slice” is a logical partition of a 5G network that provides specific network capabilities and characteristics, e.g., in support of a particular service. A network slice instance is a set of NF instances and the required network resources (e.g., compute, storage, communication) that provide the capabilities and characteristics of the network slice. The NSSF enables other NFs (e.g., AMF) to identify a network slice instance that is appropriate for a UE's desired service.
Authentication Server Function (AUSF) with Nausf interface—based in a user's home network (HPLMN), it performs user authentication and computes security key materials for various purposes.
Location Management Function (LMF) with Nlmf interface—supports various functions related to determination of UE locations, including location determination for a UE and obtaining any of the following: DL location measurements or a location estimate from the UE; UL location measurements from the NG RAN; and non-UE associated assistance data from the NG RAN.
Unified Data Management (UDM) function with Nudm interface—supports generation of 3GPP authentication credentials, user identification handling, access authorization based on subscription data, and other subscriber-related functions. To provide this functionality, the UDM uses subscription data (e.g., authentication data) stored in the 5GC unified data repository (UDR, not shown in FIG. 2). In addition to the UDM, the UDR supports storage and retrieval of policy data by the PCF, as well as storage and retrieval of application data by NEF.

Communication links between the UE and a 5G network (AN and CN) can be grouped in two different strata. The UE communicates with the CN over the Non-Access Stratum (NAS), and with the AN over the Access Stratum (AS). All the NAS communication takes place between the UE and the AMF via the NAS protocol (N1 interface in FIG. 2). Security for the communications over this these strata is provided by the NAS protocol (for NAS) and the PDCP protocol (for AS).

3GPP Rel-16 introduces a new feature called authentication and key management for applications (AKMA) that is based on 3GPP user credentials in 5G, including the Internet of Things (IoT) use case. More specifically, AKMA leverages the user's AKA (Authentication and Key Agreement) credentials to bootstrap security between the UE and an application function (AF), which allows the UE to securely exchange data with an application server. The AKMA architecture can be considered an evolution of GBA (Generic Bootstrapping Architecture) specified for 5GC in 3GPP Rel-15 and is further specified in 3GPP TS 33.535 (v16.1.0).

In addition to the NEF, AUSF, and AF shown in FIG. 2 and described above, Rel-16 AKMA also utilizes an anchor function for authentication and key management for applications (AAnF). This function is shown in FIG. 2 with Naanf interface. In general, AAnF interacts with AUSFs and maintains UE AKMA contexts to be used for subsequent bootstrapping requests, e.g., by application functions. At a high level, AAnF is similar to a bootstrapping server function (BSF) defined for Rel-15 GBA.

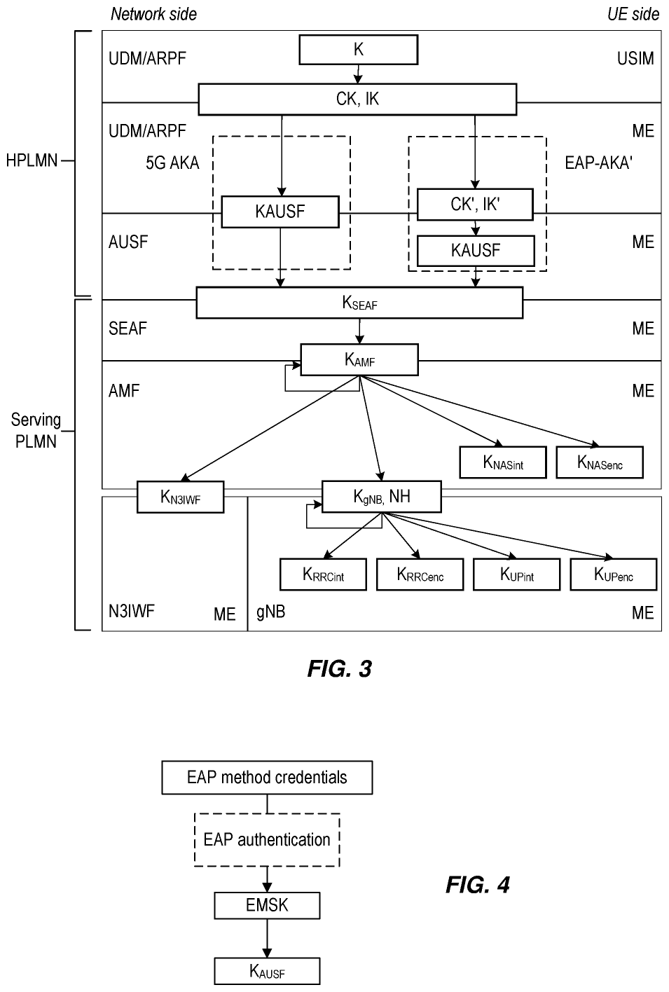

In general, security mechanisms for various 5GS protocols rely on multiple security keys. 3GPP TS 33.501 (v16.4.0) specifies these keys in the organized hierarchy shown in FIG. 3. At the top is the long-term key (K) part of the authentication credential and stored in the SIM card (USIM) on the UE side and in the UDM/ARPF in the user's HPLMN. The other part of this authentication credential is the authentication vector (CK, IK).

A successful Primary Authentication run between the UE and the AUSF in the HPLMN leads to the establishment of K_{AUSF}, the second level key in the hierarchy, as well as a transformed authentication vector (CK′, IK′). The key K_{AUSF} is not intended to leave the HPLMN and is used to secure the exchange of information between UE and HPLMN, such as for the provisioning of parameters to the UE from UDM in HPLMN. More precisely, K_{AUSF} is used for integrity protection of messages delivered from HPLMN to UE. As described in 3GPP TS 33.501, such new features include the Steering of Roaming (SoR) and the UDM parameter delivery procedures.

K_{AUSF} is used to derive another key, K_{SEAF}, that is sent to the serving PLMN. This key is then used by the serving PLMN to derive subsequent NAS and AS protection keys, i.e., K_{AMF} and various keys shown in FIG. 3 as derived directly or indirectly from K_{AMF}. These lower-level keys together with other security parameters (e.g., cryptographic algorithms, UE security capabilities, value of counters used for replay protection in various protocols, etc.) constitute the 5G security context as defined in 3GPP TS 33.501. However, higher-level key K_{AUSF} is not part of the UE's 5G security context that resides in the UE's serving PLMN.

As mentioned above, 3GPP Rel-16 also introduces support for NPNs. This feature is intended to help verticals make use of the 5G services. NPNs can be deployed as Stand-alone NPNs (SNPN) when they do not rely on network functions provided by a PLMN. Alternately, NPNs can be deployed as Public Network Integrated NPNs (PNI-NPNs) when they rely on functions provided by a PLMN.

Rel-16 enhancements specified for SNPNs include updates to the primary authentication procedures used by UEs to add support for any key-generating extensible authentication protocol (EAP) method. FIG. 4 shows a high-level view of a key hierarchy that excludes keys from outside the EAP-protocol realm. As shown in FIG. 4, K_{AUSF} is derived from authentication credentials that are specific to the EAP method. More specifically, K_{AUSF} is derived from an extended master session key (EMSK) resulting from EAP procedures.

3GPP is currently working on further enhancements to NPN supporting Rel-17. The architectural study for this work is captured in 3GPP TR 23.700-07 (v1.1.0) and the corresponding security study is captured in 3GPP TR 33.857 (v0.3.0). This work is based on the following terminology:
Default UE credentials: Information that the UE has before the actual onboarding procedure that makes the UE uniquely identifiable and verifiably secure.
Default Credential Server (DCS): The server that can authenticate a UE with default UE credentials or provide means to another entity to do it. DCS is the “external entity to the SNPN” mentioned above.
NPN credentials: Information that the UE uses for authentication to access an NPN. NPN credentials may be 3GPP credentials or non-3GPP credentials.
Onboarding Network (ON): The network providing initial registration and/or access to the UE for UE Onboarding.
Provisioning Server (PVS or PS): The server that provisions the authenticated/authorized UE with the subscription data and optionally other configuration information.
Subscription Owner (SO): The entity that stores and as result of the UE Onboarding procedures provide the subscription data and optionally other configuration information via the PVS to the UE.
UE Onboarding: Provisioning of information, to a UE and within the network, required for the UE to get authorized access and connectivity to an NPN.
Unique UE identifier: Identifying the UE in the network and the DCS and is assigned and configured by the DCS.
“Server” may include hardware, software or both.

An objective of the Rel-17 work is enhanced UE authentication procedures that facilitate UE authentication by an external entity to the SNPN. Another objective is onboarding and provisioning of credentials to UEs that do not have an established relationship with an NPN. These UE credentials are sensitive information that must be kept hidden from any unauthorized entities. For example, if the credentials fall in the wrong hands, they can be used to impersonate the UE and gain access to restricted services.

One of the candidate solutions for provisioning credentials to UEs is described in 3GPP TR 23.700-07 section 6.5. This control-plane (CP) solution leverages the UE Parameter Update (UPU) procedure described in 3GPP TS 23.502 (v16.6.0) section 4.20, which allows the UDM in HPLMN to update a UE with a set of parameters. This provisioning is integrity protected as described in 3GPP TS 33.501 (v16.4.0).

The UPU integrity protection relies on a service provided by the AUSF, whereby the UDM provides the UPU parameters to the AUSF and the AUSF returns a Message Authentication Code (MAC) referred to as UPU-MAC-I_{AUSF}. This MAC is calculated using K_{AUSF} and a freshness parameter, Counter_{UPU}, maintained by the AUSF and the UE. The Counter_{UPU} parameter is incremented at each invocation of the service and reset when K_{AUSF} is renewed. The calculation of the MAC is described in detail in 3GPP TS 33.501 Annex A.20.

Given the sensitivity of these credentials, it is highly desirable that they be protected from the provisioning UDM to the receiving UE. Although UPU fully protects UE credentials over the air interface from the RAN to the UE, UPU does not hide the credentials from network entities on the CP path between UDM and UE, including AMF and RAN nodes (e.g., serving gNB). As such, conventional UPU leaves sensitive UE credentials exposed to eavesdropping, interception, etc. along the provisioning path. Although the UPU procedure can securely deliver data via a Secure Packet mechanism a universal integrated circuit card (UICC, also known as a SIM) within the UE, this mechanism cannot be used to securely provision credentials to UEs without UICCs.

Embodiments of the present disclosure address these and other problems, issues, and/or difficulties by providing novel, flexible, and efficient techniques for delivering an encrypted payload via the UPU procedure, including use of various security parameters. Furthermore, such techniques facilitate negotiation of such security parameters without additional signaling overhead towards the UE.

These embodiments can provide various benefits and/or advantages. At a high level, such techniques provide confidentiality protection for a UPU procedure from an HPLM UDM to a UE. Furthermore, such techniques do not require a negotiation procedure to establish the security parameters required for encryption. Also, such techniques do not incur any signaling overhead towards the UE and can be used independent of whether the UE includes a UICC.

At a high level, embodiments can be based on a pre-established trust relationship between the PVS and the NFs involved in the UPU procedure, including AUSF and UDM. This trust relationship can be deployment-specific but is at least between the PVS and whatever NF generates security parameters used to protect the PVS data, regardless of how the involved NFs are deployed. In certain embodiments discussed in more detail below, the PVS can implement the necessary functionality to trigger the UPU procedure without the involvement of an external UDM. In such embodiments, the PVS must trust only the AUSF regardless of where the AUSF is deployed.

Second, embodiments are based on a previous successful authentication of the UE by the ON, e.g., using default UE credentials. Such a successful authentication results in establishment of K_{AUSF} in the UE and the AUSF. This can be done in various ways according to different scenarios, whose details are outside the scope of techniques disclosed herein.

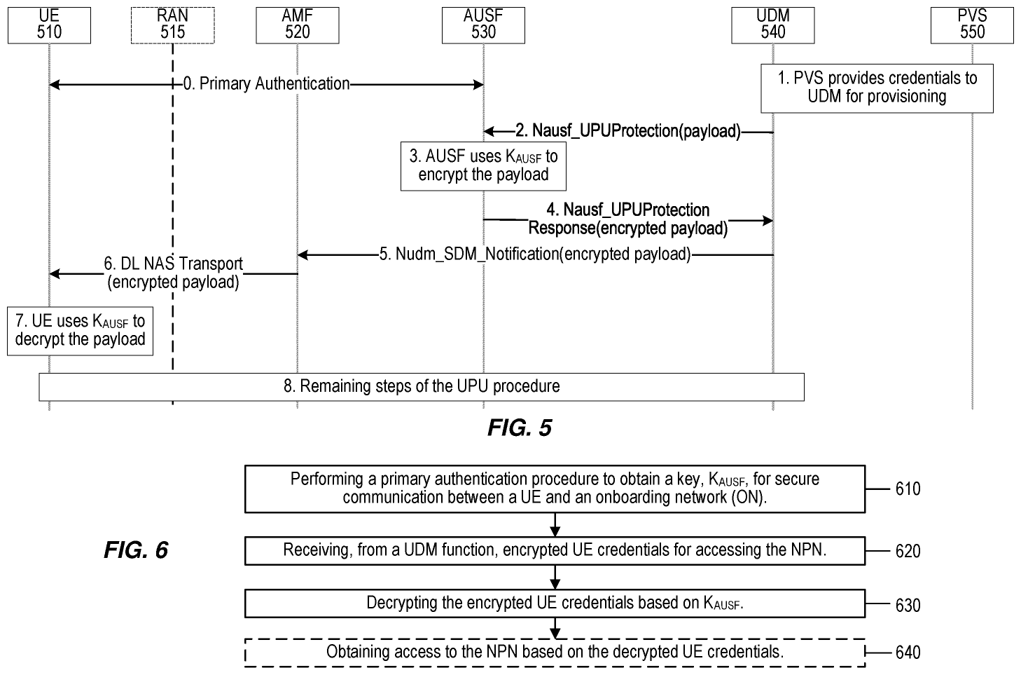

FIG. 5 shows a signal flow diagram of an exemplary UE credential provisioning procedure for an NPN, according to various embodiments of the present disclosure. Although the operations shown in FIG. 5 are given numerical labels, these are meant to facilitate explanation and do not imply any strict temporal order of the operations, unless specifically noted otherwise. The procedure shown in FIG. 5 is between a UE (510), an AMF (520), an AUSF (530), a UDM (540), and a PVS (550), which are referred to below without their respective reference numbers. Although not explicit in the discussion below, the AMF communicates with the UE via a RAN (515).

In operation 0, the UE performs a successful primary authentication procedure with the AUSF of the ON. This results in establishment of K_{AUSF} between the UE and the AUSF. In operation 1, the PVS provisions to the UDM the UE credentials or a payload containing the credentials in combination with any other parameters.

In operation 2, the UDM invokes UPU security services by sending a Nausf_UPUProtection message to the AUSF, including the credentials payload destined for the UE. In operation 3, the AUSF uses K_{AUSF} to encrypt the payload, as described in more detail below. In operation 4, the AUSF includes the encrypted payload in a Nausf_UPUProtection Response message to the UDM.

In operation 5, the UDM includes the encrypted payload (optionally together with other parameters) in a Nudm_SDM_Notification message to the AMF. In operation 6, the AMF delivers the encrypted payload to the UE in a DL NAS Transport message. In operation 7, the UE uses K_{AUSF} to decrypt the payload as described in more detail below. Operation 8 represents the subsequent operations of the UPU procedure, which are omitted from this description for the sake of brevity.

As mentioned above, embodiments do not require any additional signaling overhead to negotiate a cryptographic algorithm used to encrypt the payload. In some embodiments, a hash message authentication code (HMAC) function defined in IETF RFC 2104 can be used to encrypt the payload (in operation 3 of FIG. 5) using K_{AUSF}, Counter_{UPU}, and possibly other parameters such as a particular FC value specifically allocated for that purpose.

HMAC is used in the Key Derivation Function (KDF) defined in 3GPP TS 33.220 (v16.2.0) for the Generic Bootstrapping Architecture (GBA). This KDF is used in the calculation of all derivative keys in the hierarchy shown in FIG. 3. The parameter FC is used to distinguish between different instances of the KDF algorithm, with different ranges of FC values allocated for different purposes or applications as defined further in 3GPP TS 33.220 Annex B.2.2.

In addition, HMAC is also used in the calculation of MAC-I parameters associated with the UPU procedure. Although HMAC is a keyed hash function, it has the properties of a secure Pseudo Random Function (PRF). Thus, at least in theory HMAC can be used to construct an encryption function. Even so, other techniques can be used to construct encryption functions suitable for the disclosed embodiments.

In other embodiments, one of the mandatory-to-support encryption algorithms can be used to encrypt the payload in FIG. 5 operation 3. For example, a particular algorithm could be mandated for this purpose such that all UEs and NFs would need to implement the particular algorithm for protection of payloads transported in the UPU procedure.

In some embodiments, the key used to encrypt the credentials can be derived from K_{AUSF} using the standardized KDF function, a specific FC value allocated for UPU key derivation, and possibly other parameters. Such a key would be dedicated to payload encryption/decryption in the UPU procedure. This key, together with the Counter_{UPU} parameter, is then used with the HMAC-based algorithm mentioned above to encrypt the credentials payload in the network and to decrypt it at the UE.

In other embodiments, K_{AUSF} can be used directly for encrypting the credentials payload of the UPU procedure. To avoid limiting the usage of K_{AUSF} to only this purpose, an FC value unique to the UPU procedure can be input with K_{AUSF} to the chose encryption algorithm. For example, K_{AUSF} can be used directly for MAC computation in both the SoR and UPU procedures, but with different FC values.

In some embodiments, there can be a trust relationship between the PVS and the UDM/AUSF in the ON. In such embodiments, the PVS can provide the credentials payload to the UDM, which invokes the UPU procedure to deliver the protected credentials payload to the UE. Even so, invoking the UPU procedure requires the UDM to interact with the AUSF, which maintains security keys such as K_{AUSF}.

In other embodiments, the PVS can be enhanced with UDM (or UDM-like) functionalities that are sufficient to invoke the UPU procedure. In such embodiments, the PVS triggers the UPU procedure and interacts with the AUSF directly to secure the payload and send it to the UE without any involvement of the UDM in the onboarding networks. These embodiments are advantageous in that they involve fewer NFs in the ON and require trust only between PVS and AUSF.

Moreover, such embodiments can be similar and/or analogous to a control plane version of AKMA. Furthermore, in such embodiments, it is not necessary that the ON is the SO's SNPN (SO-SNPN). In other words, the ON can be any access network and the UDM can be elsewhere in the SO-SNPN.

In other embodiments, the PVS can receive from the AUSF a key (e.g., called K_{PVS}) derived from K_{AUSF}. The PVS uses K_{PVS} to encrypt the payload using either the MAC construct or another encryption scheme that is supported by the UE (e.g., Advanced Encryption Scheme, AES). The PVS then sends the encrypted payload to the ON UDM, which forwards the encrypted payload to the UE via UPU (i.e., normal UPU with integrity only, since the payload is already encrypted). These embodiments are advantageous in that neither AUSF nor UDM of the ON require access to the plaintext payload (although AUSF has access to a key to decrypt the encrypted payload).

In other embodiments the payload encrypted by K_{PVS} can be transferred from PVS to the UE via some other CP mechanism, such as the DoNAS feature that can be used to deliver non-IP packets to the UE via NAS signaling. DoNAS is a Rel-16 features introduced for 5G, particularly for Cellular Internet of Things (CIoT) and optimization for transport of small amount of user data.

Some of the expected NPN-related Rel-17 enhancements are related to primary authentication. In this respect, it is expected that primary authentication can be performed between the UE and ON based on default UE credentials stored in an external entity, e.g., a DCS. This could be done in various ways. For example, the DCS could endorse the role of the AUSF. As another example, the DCS could provide the necessary key (e.g., K_{AUSF}/K_{SEAF}) to the AUSF upon successful authentication. Other variations are also possible.

In other embodiments, DCS and PVS can be collocated in certain deployments. The DCS is capable of deriving 5GS keys including K_{AUSF} from EMSK, which is the output keying material from a key-generating extensible authentication protocol (EAP) method. In this case, the PVS can encrypt the UPU credentials payload with K_{AUSF} and only provide K_{SEAF} to the ON, which prevents the ON from decrypting the payload. In such embodiments, the PVS can invoke the UPU procedure without involvement of any NFs in the ON, except for relaying messages to the UE.

The embodiments described above can be further illustrated with reference to FIGS. 6-9, which depict exemplary methods (e.g., procedures) performed by a UE, an AUSF, a UDM, and a PVS respectively. Put differently, various features of the operations described below correspond to various embodiments described above. The exemplary methods shown in FIGS. 6-9 can be complementary to each other such that they can be used cooperatively to provide benefits, advantages, and/or solutions to problems described herein. Although the exemplary methods are illustrated in FIGS. 6-9 by specific blocks in particular orders, the operations corresponding to the blocks can be performed in different orders than shown and can be combined and/or divided into operations having different functionality than shown. Optional blocks and/or operations are indicated by dashed lines.

More specifically, FIG. 6 illustrates an exemplary method (e.g., procedure) to obtain security credentials for accessing an NPN, according to various embodiments of the present disclosure. The exemplary method shown in FIG. 6 can be performed by a UE (e.g., wireless device) such as described elsewhere herein. For example, the NPN can be a standalone NPN (SNPN). The security credentials can include encrypted and/or unencrypted UE credentials, as explained in more detail below.

The exemplary method can include the operations of block 610, where the UE can perform a primary authentication procedure to obtain a key K_{AUSF} for secure communication between the UE and an onboarding network (ON). The exemplary method can also include the operations of block 620, where the UE can receive, from a UDM function, encrypted UE credentials for accessing the NPN. The exemplary method can also include the operations of block 630, where the UE can decrypt the encrypted UE credentials based on K_{AUSF}.

Examples of the operations of blocks 610-630 include operations 0, 6, and 7, respectively, shown in FIG. 5. In some embodiments, the exemplary method can also include the operations of block 640, where the UE can obtain access to the NPN based on the decrypted UE credentials.

In some embodiments, one of the following cryptographic algorithms or functions is used to decrypt the encrypted UE credentials (e.g., in block 630): a hash message authentication code (HMAC) function; or a particular cryptographic algorithm used (e.g., specified by 3GPP) for protection of UE Parameter Update (UPU) procedure payloads. In some embodiments, one of the following keys is used to decrypt the UE credentials (e.g., in block 630): K_{AUSF}; or a key derived from K_{AUSF} based on a GBA KDF and a specific FC value allocated for UPU key derivation.

In some embodiments, the encrypted UE credentials can be received (e.g., in block 620) in control plane (CP) non-access stratum (NAS) signaling from an AMF associated with the NPN. In some embodiments, the UDM function can be part of a PVS for the NPN. In some embodiments, the primary authentication (e.g., in block 610) can be based on default UE credentials.

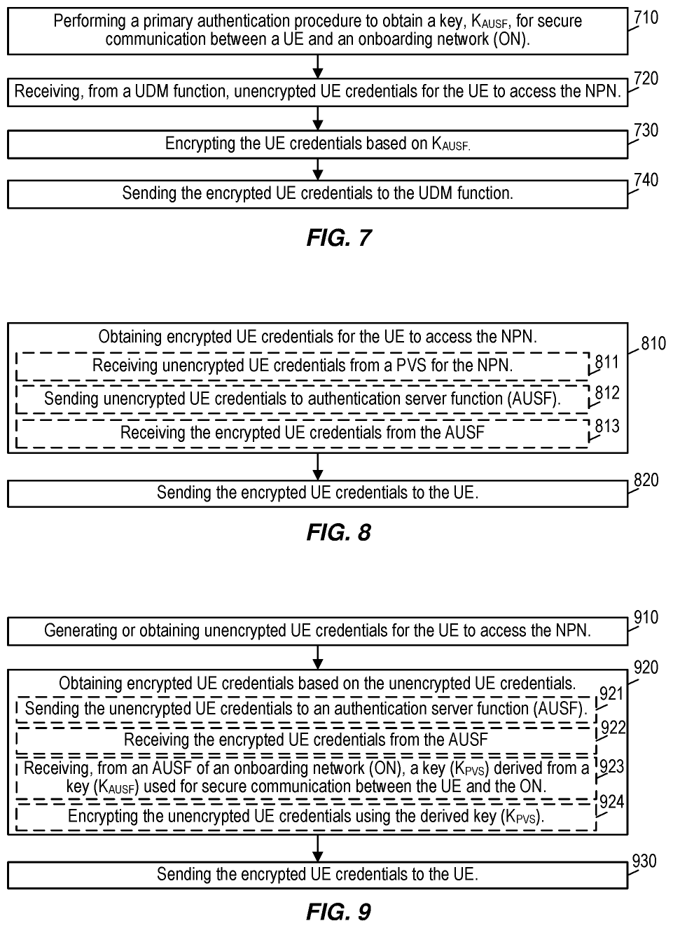

In addition, FIG. 7 illustrates an exemplary method (e.g., procedure) to facilitate UE access to an NPN, according to various embodiments of the present disclosure. The exemplary method shown in FIG. 7 can be performed by an AUSF, such as described herein with reference to other figures. For example, the NPN can be an SNPN.

The exemplary method can include the operations of block 710, where the AUSF can perform a primary authentication procedure to obtain a key K_{AUSF} for secure communication between the UE and an ON. The exemplary method can also include the operations of block 720, where the AUSF can receive, from a UDM function, unencrypted UE credentials for the UE to access the NPN. The exemplary method can also include the operations of block 730, where the AUSF can encrypt the UE credentials based on K_{AUSF}. The exemplary method can also include the operation of block 740, where the AUSF can send the encrypted UE credentials to the UDM function. Examples of the operations of blocks 710-740 include operations 0 and 2-4, respectively, shown in FIG. 5.

In some embodiments, one of the following cryptographic algorithms or functions can be used to encrypt the UE credentials (e.g., in block 730): an HMAC function, or a particular cryptographic algorithm used (e.g., specified by 3GPP) for protection of UPU procedure payloads. In some embodiments, one of the following keys can be used to encrypt the UE credentials (e.g., in block 730): K_{AUSF}; or a key derived from K_{AUSF} based on a GBA KDF and a specific FC value allocated for UPU key derivation.

In some embodiments, the UDM function can be part of a PVS for the NPN. In other embodiments, a trust relationship can exist between the AUSF and a PVS for the NPN before receiving the unencrypted UE credentials (e.g., in block 720). This can be the case, for example, when the AUSF is part of the ON. In some embodiments, the primary authentication (e.g., in block 710) can be based on default UE credentials obtained by the AUSF from a default credential server (DCS).

In addition, FIG. 8 illustrates another exemplary method (e.g., procedure) to facilitate UE access to an NPN, according to various embodiments of the present disclosure. The exemplary method shown in FIG. 8 can be performed by a UDM function, such as described herein with reference to other figures. For example, the NPN can be an SNPN.

The exemplary method can include the operations of block 810, where the UDM function can obtain encrypted UE credentials for the UE to access the NPN, from a PVS for the NPN or from an AUSF. The exemplary method can also include the operations of block 820, where the UDM function can send the encrypted UE credentials to the UE.

In some embodiments, the obtaining operations in block 810 can include the operations of sub-blocks 812-813, where the UDM can send unencrypted UE credentials to the AUSF and receive the encrypted UE credentials from the AUSF. FIG. 5 operations 2 and 4 are examples of such operations. In some of these embodiments, the obtaining operations of block 810 can also include the operations of sub-block 811, where the UE can receive the unencrypted UE credentials from a PVS for the NPN. FIG. 5 operation 1 is an example of such operations. In such embodiments, a trust relationship can exist between the UDM and the PVS before receiving the unencrypted UE credentials (e.g., in sub-block 811). This can be the case, for example, when the UDM is part of the ON.

In other embodiments, the UDM can be part of a PVS for the NPN.

In some embodiments, the encrypted UE credentials are encrypted (e.g., by AUSF) based on one of the following cryptographic algorithms or functions: an HMAC function, or a particular cryptographic algorithm used (e.g., specified by 3GPP) for protection of UPU procedure payloads. In some embodiments, the encrypted UE credentials are encrypted (e.g., by AUSF) based on one of the following keys: K_{AUSF}; or a key derived from K_{AUSF} based on a GBA KDF and a specific FC value allocated for UPU key derivation.

In addition, FIG. 9 illustrates another exemplary method (e.g., procedure) to facilitate UE access to an NPN, according to various embodiments of the present disclosure. The exemplary method shown in FIG. 9 can be performed by a PVS for the NPN, such as described herein with reference to other figures. For example, the NPN can be an SNPN.

The exemplary method can include the operations of block 910, where the PVS can generate or obtain unencrypted UE credentials for the UE to access the NPN. The exemplary method can also include the operations of block 920, where the PVC can obtain encrypted UE credentials based on the unencrypted UE credentials. The exemplary method can also include the operations of block 930, where the PVS can send the encrypted UE credentials to the UE.

In some embodiments, the obtaining operations of block 920 can include the operations of sub-blocks 921-922, where the PVS can send the unencrypted UE credentials to an AUSF and receive the encrypted UE credentials from the AUSF. This can be done, for example, when the PVS includes a UDM function. In some of these embodiments, a trust relationship can exist between the AUSF and the PVS before sending the unencrypted UE credentials (e.g., in sub-block 911). Such a trust relationship can exist, for example, when the AUSF is part of an ON.

In some of these embodiments, the encrypted UE credentials are encrypted (e.g., by AUSF) based on one of the following keys: K_{AUSF}; or a key derived from K_{AUSF} based on a GBA KDF and a specific FC value allocated for UPU key derivation. In some of these embodiments, the encrypted UE credentials can be sent to the UE (e.g., in block 920) via an AMF associated with the NPN.

In other embodiments, the obtaining operations of block 920 can include the operations of sub-blocks 923-924. In sub-block 923, the PVS can receive, from an AUSF of an ON, a key (K_{PVS}) derived from a key (K_{AUSF}) used for secure communication between the UE and the ON. In sub-block 924, the PVS can encrypt the unencrypted UE credentials using the derived key (K_{PVS}). In such embodiments, the encrypted UE credentials can be sent to the UE (e.g., in block 930) via a UDM and an AMF, both associated with the NPN.

In some embodiments, the encrypted UE credentials can be encrypted (e.g., by PVS or AUSF) based on one of the following cryptographic algorithms or functions: an HMAC function; or a particular cryptographic algorithm used (e.g., specified by 3GPP) for protection of UPU procedure payloads.

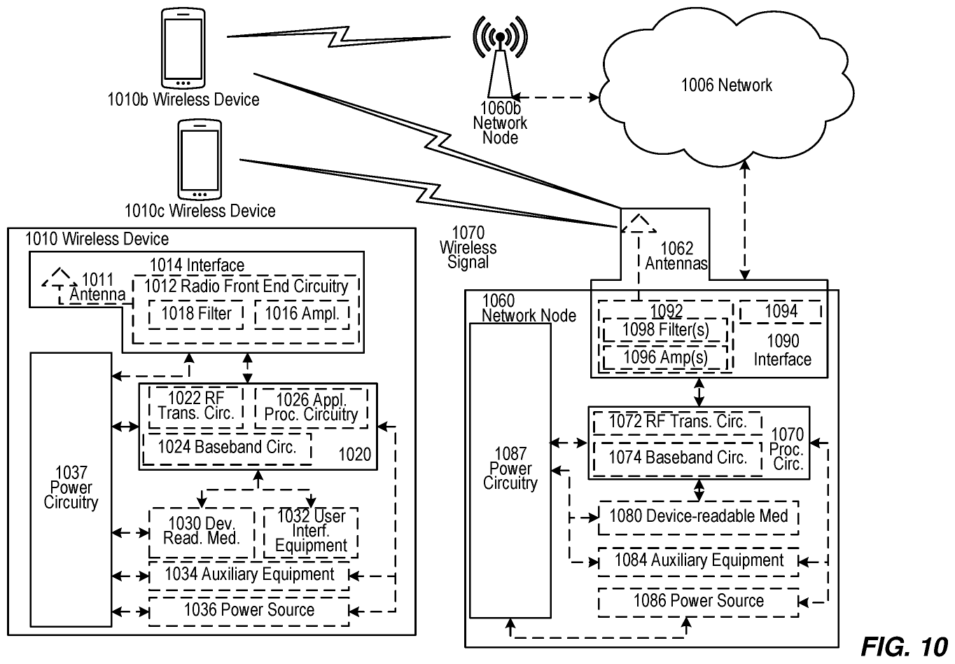

Although the subject matter described herein can be implemented in any appropriate type of system using any suitable components, the embodiments disclosed herein are described in relation to a wireless network, such as the example wireless network illustrated in FIG. 10. For simplicity, the wireless network of FIG. 10 only depicts network 1006, network nodes 1060 and 1060b, and wireless devices (WDs) 1010, 1010b, and 1010c. In practice, a wireless network can further include any additional elements suitable to support communication between wireless devices or between a wireless device and another communication device, such as a landline telephone, a service provider, or any other network node or end device. Of the illustrated components, network node 1060 and WD 1010 are depicted with additional detail. The wireless network can provide communication and other types of services to one or more wireless devices to facilitate the wireless devices' access to and/or use of the services provided by, or via, the wireless network.

The wireless network can comprise and/or interface with any type of communication, telecommunication, data, cellular, and/or radio network or other similar type of system. In some embodiments, the wireless network can be configured to operate according to specific standards or other types of predefined rules or procedures. Thus, particular embodiments of the wireless network can implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 1006 can comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 1060 and WD 1010 comprise various components described in more detail below. These components work together in order to provide network node and/or wireless device functionality, such as providing wireless connections in a wireless network. In different embodiments, the wireless network can comprise any number of wired or wireless networks, network nodes, base stations, controllers, wireless devices, relay stations, and/or any other components or systems that can facilitate or participate in the communication of data and/or signals whether via wired or wireless connections.

Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations can be categorized based on the amount of coverage they provide (or, stated differently, their transmit power level) and can then also be referred to as femto base stations, pico base stations, micro base stations, or macro base stations. A base station can be a relay node or a relay donor node controlling a relay. A network node can also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station can also be referred to as nodes in a distributed antenna system (DAS).

Further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node can be a virtual network node as described in more detail below. More generally, however, network nodes can represent any suitable device (or group of devices) capable, configured, arranged, and/or operable to enable and/or provide a wireless device with access to the wireless network or to provide some service to a wireless device that has accessed the wireless network.

In FIG. 10, network node 1060 includes processing circuitry 1070, device readable medium 1080, interface 1090, auxiliary equipment 1084, power source 1086, power circuitry 1087, and antenna 1062. Although network node 1060 illustrated in the example wireless network of FIG. 10 can represent a device that includes the illustrated combination of hardware components, other embodiments can comprise network nodes with different combinations of components. It is to be understood that a network node comprises any suitable combination of hardware and/or software needed to perform the tasks, features, functions and methods and/or procedures disclosed herein. Moreover, while the components of network node 1060 are depicted as single boxes located within a larger box, or nested within multiple boxes, in practice, a network node can comprise multiple different physical components that make up a single illustrated component (e.g., device readable medium 1080 can comprise multiple separate hard drives as well as multiple RAM modules).

Similarly, network node 1060 can be composed of multiple physically separate components (e.g., a NodeB component and an RNC component, or a BTS component and a BSC component, etc.), which can each have their own respective components. In certain scenarios in which network node 1060 comprises multiple separate components (e.g., BTS and BSC components), one or more of the separate components can be shared among several network nodes. For example, a single RNC can control multiple NodeB's. In such a scenario, each unique NodeB and RNC pair, can in some instances be considered a single separate network node. In some embodiments, network node 1060 can be configured to support multiple radio access technologies (RATs). In such embodiments, some components can be duplicated (e.g., separate device readable medium 1080 for the different RATs) and some components can be reused (e.g., the same antenna 1062 can be shared by the RATs). Network node 1060 can also include multiple sets of the various illustrated components for different wireless technologies integrated into network node 1060, such as, for example, GSM, WCDMA, LTE, NR, WiFi, or Bluetooth wireless technologies. These wireless technologies can be integrated into the same or different chip or set of chips and other components within network node 1060.

Processing circuitry 1070 can be configured to perform any determining, calculating, or similar operations (e.g., certain obtaining operations) described herein as being provided by a network node. These operations performed by processing circuitry 1070 can include processing information obtained by processing circuitry 1070 by, for example, converting the obtained information into other information, comparing the obtained information or converted information to information stored in the network node, and/or performing one or more operations based on the obtained information or converted information, and as a result of said processing making a determination.

Processing circuitry 1070 can comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide various functionality of network node 1060, either alone or in conjunction with other network node 1060 components (e.g., device readable medium 1080). Such functionality can include any of the various wireless features, functions, or benefits discussed herein.

For example, processing circuitry 1070 can execute instructions stored in device readable medium 1080 or in memory within processing circuitry 1070. In some embodiments, processing circuitry 1070 can include a system on a chip (SOC). As a more specific example, instructions (also referred to as a computer program product) stored in medium 1080 can include instructions that, when executed by processing circuitry 1070, can configure network node 1060 to perform operations corresponding to various exemplary methods (e.g., procedures) described herein.

In some embodiments, processing circuitry 1070 can include one or more of radio frequency (RF) transceiver circuitry 1072 and baseband processing circuitry 1074. In some embodiments, radio frequency (RF) transceiver circuitry 1072 and baseband processing circuitry 1074 can be on separate chips (or sets of chips), boards, or units, such as radio units and digital units. In alternative embodiments, part or all of RF transceiver circuitry 1072 and baseband processing circuitry 1074 can be on the same chip or set of chips, boards, or units

In certain embodiments, some or all of the functionality described herein as being provided by a network node, base station, eNB or other such network device can be performed by processing circuitry 1070 executing instructions stored on device readable medium 1080 or memory within processing circuitry 1070. In alternative embodiments, some or all of the functionality can be provided by processing circuitry 1070 without executing instructions stored on a separate or discrete device readable medium, such as in a hard-wired manner. In any of those embodiments, whether executing instructions stored on a device readable storage medium or not, processing circuitry 1070 can be configured to perform the described functionality. The benefits provided by such functionality are not limited to processing circuitry 1070 alone or to other components of network node 1060 but are enjoyed by network node 1060 as a whole, and/or by end users and the wireless network generally.

Device readable medium 1080 can comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that can be used by processing circuitry 1070. Device readable medium 1080 can store any suitable instructions, data or information, including a computer program, software, an application including one or more of logic, rules, code, tables, etc. and/or other instructions capable of being executed by processing circuitry 1070 and, utilized by network node 1060. Device readable medium 1080 can be used to store any calculations made by processing circuitry 1070 and/or any data received via interface 1090. In some embodiments, processing circuitry 1070 and device readable medium 1080 can be considered to be integrated.

Interface 1090 is used in the wired or wireless communication of signaling and/or data between network node 1060, network 1006, and/or WDs 1010. As illustrated, interface 1090 comprises port(s)/terminal(s) 1094 to send and receive data, for example to and from network 1006 over a wired connection. Interface 1090 also includes radio front end circuitry 1092 that can be coupled to, or in certain embodiments a part of, antenna 1062. Radio front end circuitry 1092 comprises filters 1098 and amplifiers 1096. Radio front end circuitry 1092 can be connected to antenna 1062 and processing circuitry 1070. Radio front end circuitry can be configured to condition signals communicated between antenna 1062 and processing circuitry 1070. Radio front end circuitry 1092 can receive digital data that is to be sent out to other network nodes or WDs via a wireless connection. Radio front end circuitry 1092 can convert the digital data into a radio signal having the appropriate channel and bandwidth parameters using a combination of filters 1098 and/or amplifiers 1096. The radio signal can then be transmitted via antenna 1062. Similarly, when receiving data, antenna 1062 can collect radio signals which are then converted into digital data by radio front end circuitry 1092. The digital data can be passed to processing circuitry 1070. In other embodiments, the interface can comprise different components and/or different combinations of components.

In certain alternative embodiments, network node 1060 may not include separate radio front end circuitry 1092, instead, processing circuitry 1070 can comprise radio front end circuitry and can be connected to antenna 1062 without separate radio front end circuitry 1092. Similarly, in some embodiments, all or some of RF transceiver circuitry 1072 can be considered a part of interface 1090. In still other embodiments, interface 1090 can include one or more ports or terminals 1094, radio front end circuitry 1092, and RF transceiver circuitry 1072, as part of a radio unit (not shown), and interface 1090 can communicate with baseband processing circuitry 1074, which is part of a digital unit (not shown).

Antenna 1062 can include one or more antennas, or antenna arrays, configured to send and/or receive wireless signals. Antenna 1062 can be coupled to radio front end circuitry 1090 and can be any type of antenna capable of transmitting and receiving data and/or signals wirelessly. In some embodiments, antenna 1062 can comprise one or more omni-directional, sector or panel antennas operable to transmit/receive radio signals between, for example, 2 GHz and 66 GHz. An omni-directional antenna can be used to transmit/receive radio signals in any direction, a sector antenna can be used to transmit/receive radio signals from devices within a particular area, and a panel antenna can be a line of sight antenna used to transmit/receive radio signals in a relatively straight line. In some instances, the use of more than one antenna can be referred to as MIMO. In certain embodiments, antenna 1062 can be separate from network node 1060 and can be connectable to network node 1060 through an interface or port.

Antenna 1062, interface 1090, and/or processing circuitry 1070 can be configured to perform any receiving operations and/or certain obtaining operations described herein as being performed by a network node. Any information, data and/or signals can be received from a wireless device, another network node and/or any other network equipment. Similarly, antenna 1062, interface 1090, and/or processing circuitry 1070 can be configured to perform any transmitting operations described herein as being performed by a network node. Any information, data and/or signals can be transmitted to a wireless device, another network node and/or any other network equipment.

Power circuitry 1087 can comprise, or be coupled to, power management circuitry and can be configured to supply the components of network node 1060 with power for performing the functionality described herein. Power circuitry 1087 can receive power from power source 1086. Power source 1086 and/or power circuitry 1087 can be configured to provide power to the various components of network node 1060 in a form suitable for the respective components (e.g., at a voltage and current level needed for each respective component). Power source 1086 can either be included in, or external to, power circuitry 1087 and/or network node 1060. For example, network node 1060 can be connectable to an external power source (e.g., an electricity outlet) via an input circuitry or interface such as an electrical cable, whereby the external power source supplies power to power circuitry 1087. As a further example, power source 1086 can comprise a source of power in the form of a battery or battery pack which is connected to, or integrated in, power circuitry 1087. The battery can provide backup power should the external power source fail. Other types of power sources, such as photovoltaic devices, can also be used.

Alternative embodiments of network node 1060 can include additional components beyond those shown in FIG. 10 that can be responsible for providing certain aspects of the network node's functionality, including any of the functionality described herein and/or any functionality necessary to support the subject matter described herein. For example, network node 1060 can include user interface equipment to allow and/or facilitate input of information into network node 1060 and to allow and/or facilitate output of information from network node 1060. This can allow and/or facilitate a user to perform diagnostic, maintenance, repair, and other administrative functions for network node 1060.

Furthermore, various network functions (NFs, e.g., UDM, AUSF, AMF, PVS, etc.) described herein can be implemented with and/or hosted by different variants of network node 1060, including those variants described above. In other words, operations described above as being performed by UDM, AUSF, AMF, PVS, etc. can be performed by different variants of network node 1060.

In some embodiments, a wireless device (WD, e.g., WD 1010) can be configured to transmit and/or receive information without direct human interaction. For instance, a WD can be designed to transmit information to a network on a predetermined schedule, when triggered by an internal or external event, or in response to requests from the network. Examples of a WD include, but are not limited to, smart phones, mobile phones, cell phones, voice over IP (VoIP) phones, wireless local loop phones, desktop computers, personal digital assistants (PDAs), wireless cameras, gaming consoles or devices, music storage devices, playback appliances, wearable devices, wireless endpoints, mobile stations, tablets, laptops, laptop-embedded equipment (LEE), laptop-mounted equipment (LME), smart devices, wireless customer-premise equipment (CPE), mobile-type communication (MTC) devices, Internet-of-Things (IoT) devices, vehicle-mounted wireless terminal devices, etc.

A WD can support device-to-device (D2D) communication, for example by implementing a 3GPP standard for sidelink communication, vehicle-to-vehicle (V2V), vehicle-to-infrastructure (V2I), vehicle-to-everything (V2X) and can in this case be referred to as a D2D communication device. As yet another specific example, in an Internet of Things (IoT) scenario, a WD can represent a machine or other device that performs monitoring and/or measurements and transmits the results of such monitoring and/or measurements to another WD and/or a network node. The WD can in this case be a machine-to-machine (M2M) device, which can in a 3GPP context be referred to as an MTC device. As one particular example, the WD can be a UE implementing the 3GPP narrow band internet of things (NB-IoT) standard. Particular examples of such machines or devices are sensors, metering devices such as power meters, industrial machinery, or home or personal appliances (e.g., refrigerators, televisions, etc.) personal wearables (e.g., watches, fitness trackers, etc.). In other scenarios, a WD can represent a vehicle or other equipment that is capable of monitoring and/or reporting on its operational status or other functions associated with its operation. A WD as described above can represent the endpoint of a wireless connection, in which case the device can be referred to as a wireless terminal. Furthermore, a WD as described above can be mobile, in which case it can also be referred to as a mobile device or a mobile terminal.

As illustrated, wireless device 1010 includes antenna 1011, interface 1014, processing circuitry 1020, device readable medium 1030, user interface equipment 1032, auxiliary equipment 1034, power source 1036 and power circuitry 1037. WD 1010 can include multiple sets of one or more of the illustrated components for different wireless technologies supported by WD 1010, such as, for example, GSM, WCDMA, LTE, NR, WiFi, WiMAX, or Bluetooth wireless technologies, just to mention a few. These wireless technologies can be integrated into the same or different chips or set of chips as other components within WD 1010.

Antenna 1011 can include one or more antennas or antenna arrays, configured to send and/or receive wireless signals, and is connected to interface 1014. In certain alternative embodiments, antenna 1011 can be separate from WD 1010 and be connectable to WD 1010 through an interface or port. Antenna 1011, interface 1014, and/or processing circuitry 1020 can be configured to perform any receiving or transmitting operations described herein as being performed by a WD. Any information, data and/or signals can be received from a network node and/or another WD. In some embodiments, radio front end circuitry and/or antenna 1011 can be considered an interface.

As illustrated, interface 1014 comprises radio front end circuitry 1012 and antenna 1011. Radio front end circuitry 1012 comprise one or more filters 1018 and amplifiers 1016. Radio front end circuitry 1014 is connected to antenna 1011 and processing circuitry 1020 and can be configured to condition signals communicated between antenna 1011 and processing circuitry 1020. Radio front end circuitry 1012 can be coupled to or a part of antenna 1011. In some embodiments, WD 1010 may not include separate radio front end circuitry 1012; rather, processing circuitry 1020 can comprise radio front end circuitry and can be connected to antenna 1011. Similarly, in some embodiments, some or all of RF transceiver circuitry 1022 can be considered a part of interface 1014. Radio front end circuitry 1012 can receive digital data that is to be sent out to other network nodes or WDs via a wireless connection. Radio front end circuitry 1012 can convert the digital data into a radio signal having the appropriate channel and bandwidth parameters using a combination of filters 1018 and/or amplifiers 1016. The radio signal can then be transmitted via antenna 1011. Similarly, when receiving data, antenna 1011 can collect radio signals which are then converted into digital data by radio front end circuitry 1012. The digital data can be passed to processing circuitry 1020. In other embodiments, the interface can comprise different components and/or different combinations of components.

Processing circuitry 1020 can comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide WD 1010 functionality either alone or in combination with other WD 1010 components, such as device readable medium 1030. Such functionality can include any of the various wireless features or benefits discussed herein.

For example, processing circuitry 1020 can execute instructions stored in device readable medium 1030 or in memory within processing circuitry 1020 to provide the functionality disclosed herein. More specifically, instructions (also referred to as a computer program product) stored in medium 1030 can include instructions that, when executed by processor 1020, can configure wireless device 1010 to perform operations corresponding to various exemplary methods (e.g., procedures) described herein.

As illustrated, processing circuitry 1020 includes one or more of RF transceiver circuitry 1022, baseband processing circuitry 1024, and application processing circuitry 1026. In other embodiments, the processing circuitry can comprise different components and/or different combinations of components. In certain embodiments processing circuitry 1020 of WD 1010 can comprise a SOC. In some embodiments, RF transceiver circuitry 1022, baseband processing circuitry 1024, and application processing circuitry 1026 can be on separate chips or sets of chips. In alternative embodiments, part or all of baseband processing circuitry 1024 and application processing circuitry 1026 can be combined into one chip or set of chips, and RF transceiver circuitry 1022 can be on a separate chip or set of chips. In still alternative embodiments, part or all of RF transceiver circuitry 1022 and baseband processing circuitry 1024 can be on the same chip or set of chips, and application processing circuitry 1026 can be on a separate chip or set of chips. In yet other alternative embodiments, part or all of RF transceiver circuitry 1022, baseband processing circuitry 1024, and application processing circuitry 1026 can be combined in the same chip or set of chips. In some embodiments, RF transceiver circuitry 1022 can be a part of interface 1014. RF transceiver circuitry 1022 can condition RF signals for processing circuitry 1020.

In certain embodiments, some or all of the functionality described herein as being performed by a WD can be provided by processing circuitry 1020 executing instructions stored on device readable medium 1030, which in certain embodiments can be a computer-readable storage medium. In alternative embodiments, some or all of the functionalities can be provided by processing circuitry 1020 without executing instructions stored on a separate or discrete device readable storage medium, such as in a hard-wired manner. In any of those particular embodiments, whether executing instructions stored on a device readable storage medium or not, processing circuitry 1020 can be configured to perform the described functionality. The benefits provided by such functionality are not limited to processing circuitry 1020 alone or to other components of WD 1010, but are enjoyed by WD 1010 as a whole, and/or by end users and the wireless network generally.

Processing circuitry 1020 can be configured to perform any determining, calculating, or similar operations (e.g., certain obtaining operations) described herein as being performed by a WD. These operations, as performed by processing circuitry 1020, can include processing information obtained by processing circuitry 1020 by, for example, converting the obtained information into other information, comparing the obtained information or converted information to information stored by WD 1010, and/or performing one or more operations based on the obtained information or converted information, and as a result of said processing making a determination.

Device readable medium 1030 can be operable to store a computer program, software, an application including one or more of logic, rules, code, tables, etc. and/or other instructions capable of being executed by processing circuitry 1020. Device readable medium 1030 can include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that can be used by processing circuitry 1020. In some embodiments, processing circuitry 1020 and device readable medium 1030 can be considered to be integrated.

User interface equipment 1032 can include components that allow and/or facilitate a human user to interact with WD 1010. Such interaction can be of many forms, such as visual, audial, tactile, etc. User interface equipment 1032 can be operable to produce output to the user and to allow and/or facilitate the user to provide input to WD 1010. The type of interaction can vary depending on the type of user interface equipment 1032 installed in WD 1010. For example, if WD 1010 is a smart phone, the interaction can be via a touch screen; if WD 1010 is a smart meter, the interaction can be through a screen that provides usage (e.g., the number of gallons used) or a speaker that provides an audible alert (e.g., if smoke is detected). User interface equipment 1032 can include input interfaces, devices and circuits, and output interfaces, devices and circuits. User interface equipment 1032 can be configured to allow and/or facilitate input of information into WD 1010 and is connected to processing circuitry 1020 to allow and/or facilitate processing circuitry 1020 to process the input information. User interface equipment 1032 can include, for example, a microphone, a proximity or other sensor, keys/buttons, a touch display, one or more cameras, a USB port, or other input circuitry. User interface equipment 1032 is also configured to allow and/or facilitate output of information from WD 1010, and to allow and/or facilitate processing circuitry 1020 to output information from WD 1010. User interface equipment 1032 can include, for example, a speaker, a display, vibrating circuitry, a USB port, a headphone interface, or other output circuitry. Using one or more input and output interfaces, devices, and circuits, of user interface equipment 1032, WD 1010 can communicate with end users and/or the wireless network and allow and/or facilitate them to benefit from the functionality described herein.

Auxiliary equipment 1034 is operable to provide more specific functionality which may not be generally performed by WDs. This can comprise specialized sensors for doing measurements for various purposes, interfaces for additional types of communication such as wired communications etc. The inclusion and type of components of auxiliary equipment 1034 can vary depending on the embodiment and/or scenario.

Power source 1036 can, in some embodiments, be in the form of a battery or battery pack. Other types of power sources, such as an external power source (e.g., an electricity outlet), photovoltaic devices or power cells, can also be used. WD 1010 can further comprise power circuitry 1037 for delivering power from power source 1036 to the various parts of WD 1010 which need power from power source 1036 to carry out any functionality described or indicated herein. Power circuitry 1037 can in certain embodiments comprise power management circuitry. Power circuitry 1037 can additionally or alternatively be operable to receive power from an external power source; in which case WD 1010 can be connectable to the external power source (such as an electricity outlet) via input circuitry or an interface such as an electrical power cable. Power circuitry 1037 can also in certain embodiments be operable to deliver power from an external power source to power source 1036. This can be, for example, for the charging of power source 1036. Power circuitry 1037 can perform any converting or other modification to the power from power source 1036 to make it suitable for supply to the respective components of WD 1010.

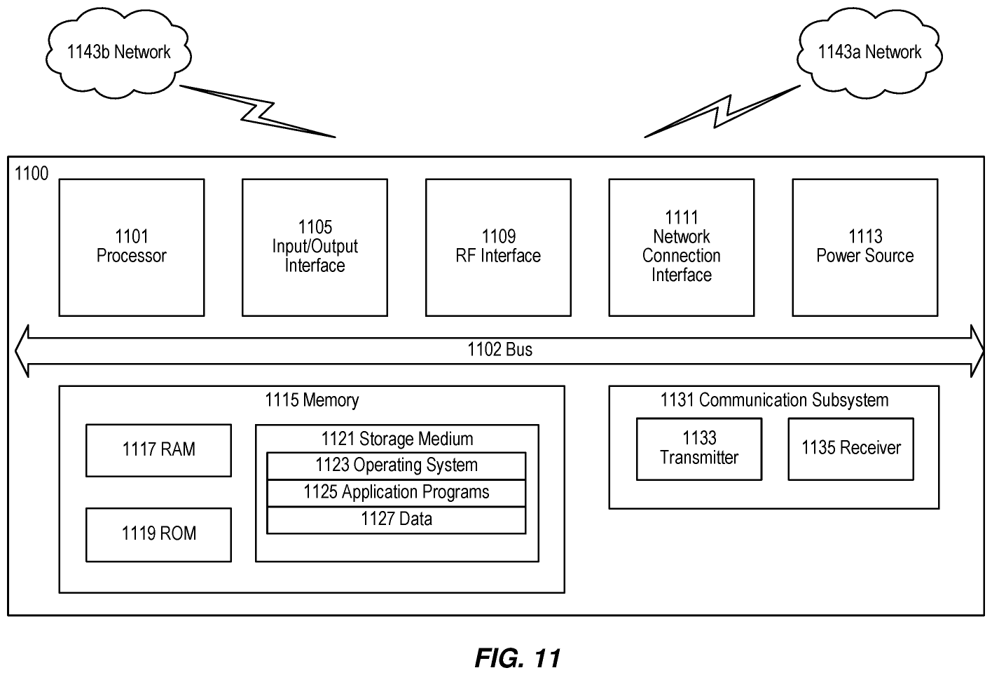

FIG. 11 illustrates one embodiment of a UE in accordance with various aspects described herein. As used herein, a user equipment or UE may not necessarily have a user in the sense of a human user who owns and/or operates the relevant device. Instead, a UE can represent a device that is intended for sale to, or operation by, a human user but which may not, or which may not initially, be associated with a specific human user (e.g., a smart sprinkler controller). Alternatively, a UE can represent a device that is not intended for sale to, or operation by, an end user but which can be associated with or operated for the benefit of a user (e.g., a smart power meter). UE 1100 can be any UE identified by the 3^{rd} Generation Partnership Project (3GPP), including a NB-IoT UE, a machine type communication (MTC) UE, and/or an enhanced MTC (eMTC) UE. UE 1100, as illustrated in FIG. 11, is one example of a WD configured for communication in accordance with one or more communication standards promulgated by the 3^{rd} Generation Partnership Project (3GPP), such as 3GPP's GSM, UMTS, LTE, and/or 5G standards. As mentioned previously, the term WD and UE can be used interchangeably. Accordingly, although FIG. 11 is a UE, the components discussed herein are equally applicable to a WD, and vice-versa.

In FIG. 11, UE 1100 includes processing circuitry 1101 that is operatively coupled to input/output interface 1105, radio frequency (RF) interface 1109, network connection interface 1111, memory 1115 including random access memory (RAM) 1117, read-only memory (ROM) 1119, and storage medium 1121 or the like, communication subsystem 1131, power source 1133, and/or any other component, or any combination thereof. Storage medium 1121 includes operating system 1123, application program 1125, and data 1127. In other embodiments, storage medium 1121 can include other similar types of information. Certain UEs can utilize all of the components shown in FIG. 11, or only a subset of the components. The level of integration between the components can vary from one UE to another UE. Further, certain UEs can contain multiple instances of a component, such as multiple processors, memories, transceivers, transmitters, receivers, etc.

In FIG. 11, processing circuitry 1101 can be configured to process computer instructions and data. Processing circuitry 1101 can be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 1101 can include two central processing units (CPUs). Data can be information in a form suitable for use by a computer.

In the depicted embodiment, input/output interface 1105 can be configured to provide a communication interface to an input device, output device, or input and output device. UE 1100 can be configured to use an output device via input/output interface 1105. An output device can use the same type of interface port as an input device. For example, a USB port can be used to provide input to and output from UE 1100. The output device can be a speaker, a sound card, a video card, a display, a monitor, a printer, an actuator, an emitter, a smartcard, another output device, or any combination thereof. UE 1100 can be configured to use an input device via input/output interface 1105 to allow and/or facilitate a user to capture information into UE 1100. The input device can include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display can include a capacitive or resistive touch sensor to sense input from a user. A sensor can be, for instance, an accelerometer, a gyroscope, a tilt sensor, a force sensor, a magnetometer, an optical sensor, a proximity sensor, another like sensor, or any combination thereof. For example, the input device can be an accelerometer, a magnetometer, a digital camera, a microphone, and an optical sensor.

In FIG. 11, RF interface 1109 can be configured to provide a communication interface to RF components such as a transmitter, a receiver, and an antenna. Network connection interface 1111 can be configured to provide a communication interface to network 1143a. Network 1143a can encompass wired and/or wireless networks such as a local-area network (LAN), a wide-area network (WAN), a computer network, a wireless network, a telecommunications network, another like network or any combination thereof. For example, network 1143a can comprise a Wi-Fi network. Network connection interface 1111 can be configured to include a receiver and a transmitter interface used to communicate with one or more other devices over a communication network according to one or more communication protocols, such as Ethernet, TCP/IP, SONET, ATM, or the like. Network connection interface 1111 can implement receiver and transmitter functionality appropriate to the communication network links (e.g., optical, electrical, and the like). The transmitter and receiver functions can share circuit components, software or firmware, or alternatively can be implemented separately.

RAM 1117 can be configured to interface via bus 1102 to processing circuitry 1101 to provide storage or caching of data or computer instructions during the execution of software programs such as the operating system, application programs, and device drivers. ROM 1119 can be configured to provide computer instructions or data to processing circuitry 1101. For example, ROM 1119 can be configured to store invariant low-level system code or data for basic system functions such as basic input and output (I/O), startup, or reception of keystrokes from a keyboard that are stored in a non-volatile memory. Storage medium 1121 can be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives.

In one example, storage medium 1121 can be configured to include operating system 1123; application program 1125 such as a web browser application, a widget or gadget engine or another application; and data file 1127. Storage medium 1121 can store, for use by UE 1100, any of a variety of various operating systems or combinations of operating systems. For example, application program 1125 can include executable program instructions (also referred to as a computer program product) that, when executed by processor 1101, can configure UE 1100 to perform operations corresponding to various exemplary methods (e.g., procedures) described herein.

Storage medium 1121 can be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 1121 can allow and/or facilitate UE 1100 to access computer-executable instructions, application programs or the like, stored on transitory or non-transitory memory media, to off-load data, or to upload data. An article of manufacture, such as one utilizing a communication system can be tangibly embodied in storage medium 1121, which can comprise a device readable medium.

In FIG. 11, processing circuitry 1101 can be configured to communicate with network 1143b using communication subsystem 1131. Network 1143a and network 1143b can be the same network or networks or different network or networks. Communication subsystem 1131 can be configured to include one or more transceivers used to communicate with network 1143b. For example, communication subsystem 1131 can be configured to include one or more transceivers used to communicate with one or more remote transceivers of another device capable of wireless communication such as another WD, UE, or base station of a radio access network (RAN) according to one or more communication protocols, such as IEEE 802.11, CDMA, WCDMA, GSM, LTE, UTRAN, WiMax, or the like. Each transceiver can include transmitter 1133 and/or receiver 1135 to implement transmitter or receiver functionality, respectively, appropriate to the RAN links (e.g., frequency allocations and the like). Further, transmitter 1133 and receiver 1135 of each transceiver can share circuit components, software or firmware, or alternatively can be implemented separately.

In the illustrated embodiment, the communication functions of communication subsystem 1131 can include data communication, voice communication, multimedia communication, short-range communications such as Bluetooth, near-field communication, location-based communication such as the use of the global positioning system (GPS) to determine a location, another like communication function, or any combination thereof. For example, communication subsystem 1131 can include cellular communication, Wi-Fi communication, Bluetooth communication, and GPS communication. Network 1143b can encompass wired and/or wireless networks such as a local-area network (LAN), a wide-area network (WAN), a computer network, a wireless network, a telecommunications network, another like network or any combination thereof. For example, network 1143b can be a cellular network, a Wi-Fi network, and/or a near-field network. Power source 1113 can be configured to provide alternating current (AC) or direct current (DC) power to components of UE 1100.

The features, benefits and/or functions described herein can be implemented in one of the components of UE 1100 or partitioned across multiple components of UE 1100. Further, the features, benefits, and/or functions described herein can be implemented in any combination of hardware, software or firmware. In one example, communication subsystem 1131 can be configured to include any of the components described herein. Further, processing circuitry 1101 can be configured to communicate with any of such components over bus 1102. In another example, any of such components can be represented by program instructions stored in memory that when executed by processing circuitry 1101 perform the corresponding functions described herein. In another example, the functionality of any of such components can be partitioned between processing circuitry 1101 and communication subsystem 1131. In another example, the non-computationally intensive functions of any of such components can be implemented in software or firmware and the computationally intensive functions can be implemented in hardware.

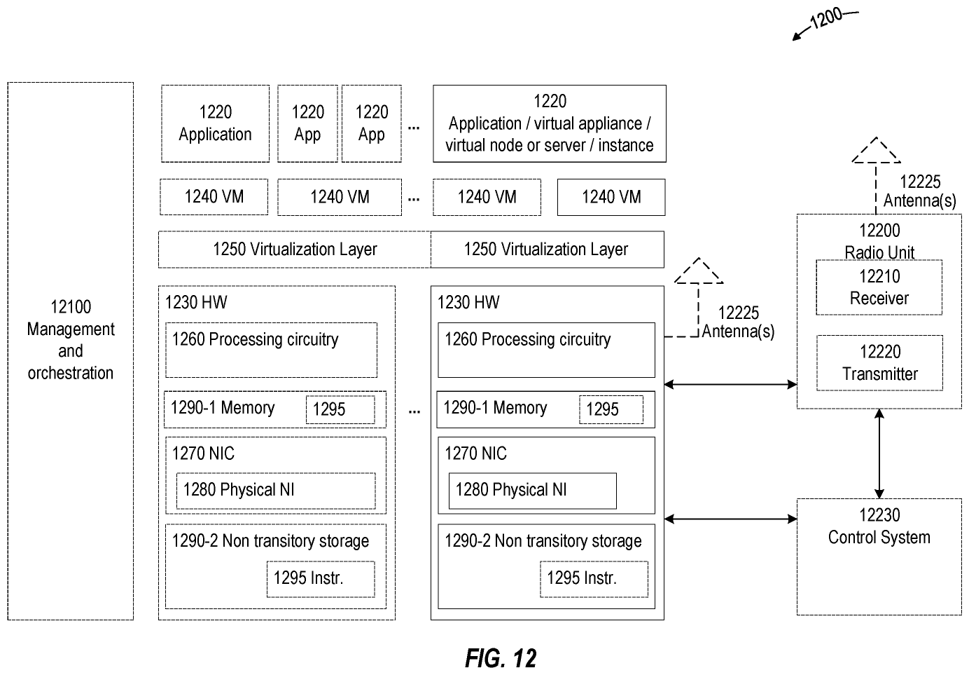

FIG. 12 is a schematic block diagram illustrating a virtualization environment 1200 in which functions implemented by some embodiments can be virtualized. In the present context, virtualizing means creating virtual versions of apparatuses or devices which can include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein can be implemented as virtual components executed by one or more virtual machines implemented in one or more virtual environments 1200 hosted by one or more of hardware nodes 1230. Further, in embodiments in which the virtual node is not a radio access node or does not require radio connectivity (e.g., a core network node), then the network node can be entirely virtualized.

The functions can be implemented by one or more applications 1220 (which can alternatively be called software instances, virtual appliances, network functions, virtual nodes, virtual network functions, etc.) operative to implement some of the features, functions, and/or benefits of some of the embodiments disclosed herein. Applications 1220 are run in virtualization environment 1200 which provides hardware 1230 comprising processing circuitry 1260 and memory 1290. Memory 1290 contains instructions 1295 executable by processing circuitry 1260 whereby application 1220 is operative to provide one or more of the features, benefits, and/or functions disclosed herein.

Virtualization environment 1200 can include general-purpose or special-purpose network hardware devices (or nodes) 1230 comprising a set of one or more processors or processing circuitry 1260, which can be commercial off-the-shelf (COTS) processors, dedicated Application Specific Integrated Circuits (ASICs), or any other type of processing circuitry including digital or analog hardware components or special purpose processors. Each hardware device can comprise memory 1290-1 which can be non-persistent memory for temporarily storing instructions 1295 or software executed by processing circuitry 1260. For example, instructions 1295 can include program instructions (also referred to as a computer program product) that, when executed by processing circuitry 1260, can configure hardware node 1220 to perform operations corresponding to various exemplary methods (e.g., procedures) described herein. Such operations can also be attributed to virtual node(s) 1220 that is/are hosted by hardware node 1230.

Each hardware device can comprise one or more network interface controllers (NICs) 1270, also known as network interface cards, which include physical network interface 1280. Each hardware device can also include non-transitory, persistent, machine-readable storage media 1290-2 having stored therein software 1295 and/or instructions executable by processing circuitry 1260. Software 1295 can include any type of software including software for instantiating one or more virtualization layers 1250 (also referred to as hypervisors), software to execute virtual machines 1240 as well as software allowing it to execute functions, features and/or benefits described in relation with some embodiments described herein.

Virtual machines 1240, comprise virtual processing, virtual memory, virtual networking or interface and virtual storage, and can be run by a corresponding virtualization layer 1250 or hypervisor. Different embodiments of the instance of virtual appliance 1220 can be implemented on one or more of virtual machines 1240, and the implementations can be made in different ways.

During operation, processing circuitry 1260 executes software 1295 to instantiate the hypervisor or virtualization layer 1250, which can sometimes be referred to as a virtual machine monitor (VMM). Virtualization layer 1250 can present a virtual operating platform that appears like networking hardware to virtual machine 1240.

As shown in FIG. 12, hardware 1230 can be a standalone network node with generic or specific components. Hardware 1230 can comprise antenna 12225 and can implement some functions via virtualization. Alternatively, hardware 1230 can be part of a larger cluster of hardware (e.g., such as in a data center or customer premise equipment (CPE)) where many hardware nodes work together and are managed via management and orchestration (MANO) 12100, which, among others, oversees lifecycle management of applications 1220.

Virtualization of the hardware is in some contexts referred to as network function virtualization (NFV). NFV can be used to consolidate many network equipment types onto industry standard high-volume server hardware, physical switches, and physical storage, which can be located in data centers, and customer premise equipment.

In the context of NFV, virtual machine 1240 can be a software implementation of a physical machine that runs programs as if they were executing on a physical, non-virtualized machine. Each of virtual machines 1240, and that part of hardware 1230 that executes that virtual machine, be it hardware dedicated to that virtual machine and/or hardware shared by that virtual machine with others of the virtual machines 1240, forms a separate virtual network elements (VNE).

Still in the context of NFV, Virtual Network Function (VNF) is responsible for handling specific network functions that run in one or more virtual machines 1240 on top of hardware networking infrastructure 1230 and corresponds to application 1220 in FIG. 12.

In some embodiments, one or more radio units 12200 that each include one or more transmitters 12220 and one or more receivers 12210 can be coupled to one or more antennas 12225. Radio units 12200 can communicate directly with hardware nodes 1230 via one or more appropriate network interfaces and can be used in combination with the virtual components to provide a virtual node with radio capabilities, such as a radio access node or a base station. Nodes arranged in this manner can also communicate with one or more UEs, such as described elsewhere herein.

In some embodiments, some signaling can be performed via control system 12230, which can alternatively be used for communication between the hardware nodes 1230 and radio units 12200.

Furthermore, various network functions (NFs, e.g., UDM, AUSF, AMF, PVS, etc.) described herein can be implemented with and/or hosted by different variants of hardware node 1230 or virtual node 1220, including those variants described above. In other words, operations described above as being performed by UDM, AUSF, AMF, PVS, etc. can be performed by different variants of hardware node 1230 or virtual node 1220.

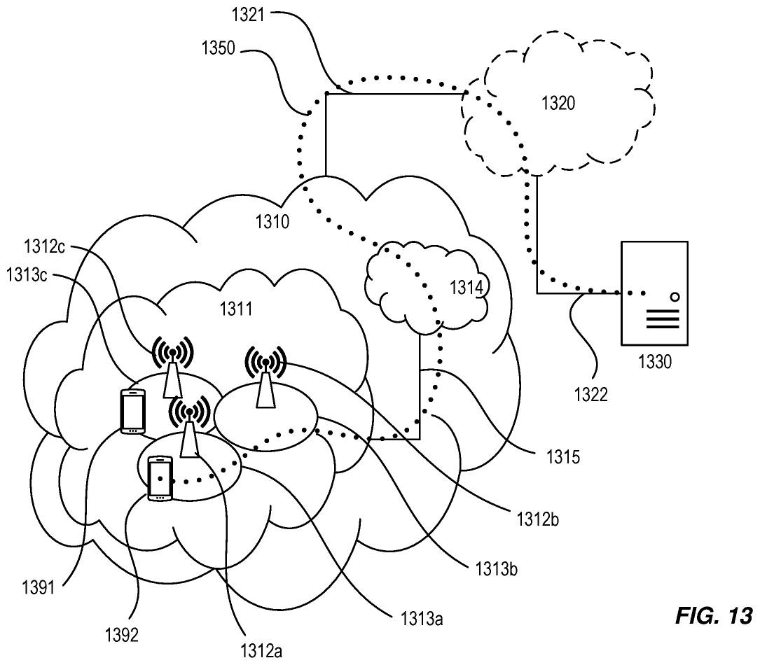

With reference to FIG. 13, in accordance with an embodiment, a communication system includes telecommunication network 1310, such as a 3GPP-type cellular network, which comprises access network 1311, such as a radio access network, and core network 1314. Access network 1311 comprises a plurality of base stations 1312a, 1312b, 1312c, such as NBs, eNBs, gNBs or other types of wireless access points, each defining a corresponding coverage area 1313a, 1313b, 1313c. Each base station 1312a, 1312b, 1312c is connectable to core network 1314 over a wired or wireless connection 1315. A first UE 1391 located in coverage area 1313c can be configured to wirelessly connect to, or be paged by, the corresponding base station 1312c. A second UE 1392 in coverage area 1313a is wirelessly connectable to the corresponding base station 1312a. While a plurality of UEs 1391, 1392 are illustrated in this example, the disclosed embodiments are equally applicable to a situation where a sole UE is in the coverage area or where a sole UE is connecting to the

Telecommunication network 1310 is itself connected to host computer 1330, which can be embodied in the hardware and/or software of a standalone server, a cloud-implemented server, a distributed server or as processing resources in a server farm. Host computer 1330 can be under the ownership or control of a service provider or can be operated by the service provider or on behalf of the service provider. Connections 1321 and 1322 between telecommunication network 1310 and host computer 1330 can extend directly from core network 1314 to host computer 1330 or can go via an optional intermediate network 1320. Intermediate network 1320 can be one of, or a combination of more than one of, a public, private or hosted network; intermediate network 1320, if any, can be a backbone network or the Internet; in particular, intermediate network 1320 can comprise two or more sub-networks (not shown).

The communication system of FIG. 13 as a whole enables connectivity between the connected UEs 1391, 1392 and host computer 1330. The connectivity can be described as an over-the-top (OTT) connection 1350. Host computer 1330 and the connected UEs 1391, 1392 are configured to communicate data and/or signaling via OTT connection 1350, using access network 1311, core network 1314, any intermediate network 1320 and possible further infrastructure (not shown) as intermediaries. OTT connection 1350 can be transparent in the sense that the participating communication devices through which OTT connection 1350 passes are unaware of routing of uplink and downlink communications. For example, base station 1312 may not or need not be informed about the past routing of an incoming downlink communication with data originating from host computer 1330 to be forwarded (e.g., handed over) to a connected UE 1391. Similarly, base station 1312 need not be aware of the future routing of an outgoing uplink communication originating from the UE 1391 towards the host computer 1330.

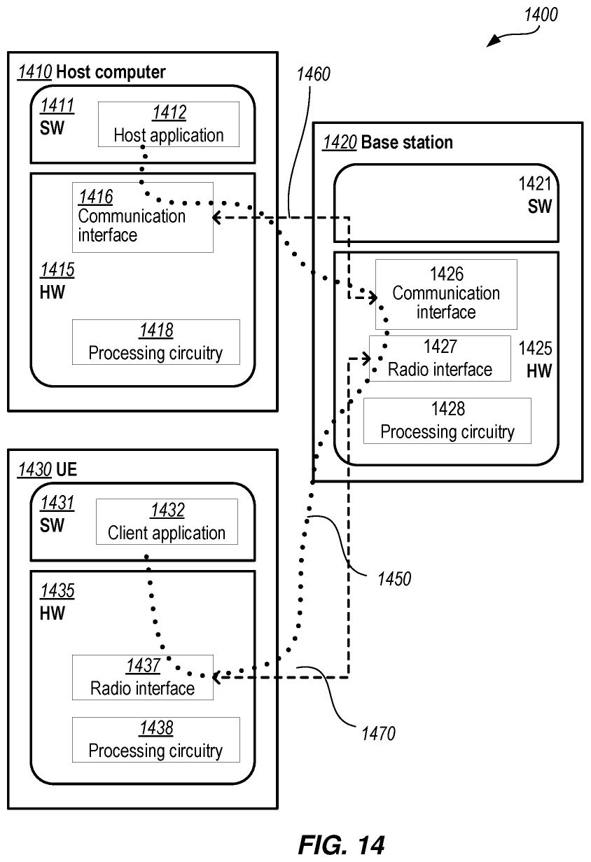

Example implementations, in accordance with an embodiment, of the UE, base station and host computer discussed in the preceding paragraphs will now be described with reference to FIG. 14. In communication system 1400, host computer 1410 comprises hardware 1415 including communication interface 1416 configured to set up and maintain a wired or wireless connection with an interface of a different communication device of communication system 1400. Host computer 1410 further comprises processing circuitry 1418, which can have storage and/or processing capabilities. In particular, processing circuitry 1418 can comprise one or more programmable processors, application-specific integrated circuits, field programmable gate arrays or combinations of these (not shown) adapted to execute instructions. Host computer 1410 further comprises software 1411, which is stored in or accessible by host computer 1410 and executable by processing circuitry 1418. Software 1411 includes host application 1412. Host application 1412 can be operable to provide a service to a remote user, such as UE 1430 connecting via OTT connection 1450 terminating at UE 1430 and host computer 1410. In providing the service to the remote user, host application 1412 can provide user data which is transmitted using OTT connection 1450.

Communication system 1400 can also include base station 1420 provided in a telecommunication system and comprising hardware 1425 enabling it to communicate with host computer 1410 and with UE 1430. Hardware 1425 can include communication interface 1426 for setting up and maintaining a wired or wireless connection with an interface of a different communication device of communication system 1400, as well as radio interface 1427 for setting up and maintaining at least wireless connection 1470 with UE 1430 located in a coverage area (not shown in FIG. 14) served by base station 1420. Communication interface 1426 can be configured to facilitate connection 1460 to host computer 1410. Connection 1460 can be direct, or it can pass through a core network (not shown in FIG. 14) of the telecommunication system and/or through one or more intermediate networks outside the telecommunication system. In the embodiment shown, hardware 1425 of base station 1420 can also include processing circuitry 1428, which can comprise one or more programmable processors, application-specific integrated circuits, field programmable gate arrays or combinations of these (not shown) adapted to execute instructions.

Base station 1420 also includes software 1421 stored internally or accessible via an external connection. For example, software 1421 can include program instructions (also referred to as a computer program product) that, when executed by processing circuitry 1428, can configure base station 1420 to perform operations corresponding to various exemplary methods (e.g., procedures) described herein.

Communication system 1400 can also include UE 1430 already referred to, whose hardware 1435 can include radio interface 1437 configured to set up and maintain wireless connection 1470 with a base station serving a coverage area in which UE 1430 is currently located. Hardware 1435 of UE 1430 can also include processing circuitry 1438, which can comprise one or more programmable processors, application-specific integrated circuits, field programmable gate arrays or combinations of these (not shown) adapted to execute instructions.

UE 1430 also includes software 1431, which is stored in or accessible by UE 1430 and executable by processing circuitry 1438. Software 1431 includes client application 1432. Client application 1432 can be operable to provide a service to a human or non-human user via UE 1430, with the support of host computer 1410. In host computer 1410, an executing host application 1412 can communicate with the executing client application 1432 via OTT connection 1450 terminating at UE 1430 and host computer 1410. In providing the service to the user, client application 1432 can receive request data from host application 1412 and provide user data in response to the request data. OTT connection 1450 can transfer both the request data and the user data. Client application 1432 can interact with the user to generate the user data that it provides. Software 1431 can also include program instructions (also referred to as a computer program product) that, when executed by processing circuitry 1438, can configure UE 1430 to perform operations corresponding to various exemplary methods (e.g., procedures) described herein.

As an example, host computer 1410, base station 1420 and UE 1430 illustrated in FIG. 14 can be similar or identical to host computer 1330, one of base stations 1312a, 1312b, 1312c and one of UEs 1391, 1392 of FIG. 13, respectively. This is to say, the inner workings of these entities can be as shown in FIG. 14 and independently, the surrounding network topology can be that of FIG. 13.

In FIG. 14, OTT connection 1450 has been drawn abstractly to illustrate the communication between host computer 1410 and UE 1430 via base station 1420, without explicit reference to any intermediary devices and the precise routing of messages via these devices. Network infrastructure can determine the routing, which it can be configured to hide from UE 1430 or from the service provider operating host computer 1410, or both. While OTT connection 1450 is active, the network infrastructure can also dynamically change the routing (e.g., based on load balancing consideration or reconfiguration of the network).

Wireless connection 1470 between UE 1430 and base station 1420 is in accordance with the teachings of the embodiments described throughout this disclosure. One or more of the various embodiments improve the performance of OTT services provided to UE 1430 using OTT connection 1450, in which wireless connection 1470 forms the last segment. More precisely, the embodiments disclosed herein can improve flexibility for the network to monitor end-to-end quality-of-service (QoS) of data flows, including their corresponding radio bearers, associated with data sessions between a user equipment (UE) and another entity, such as an OTT data application or service external to the 5G network. These and other advantages can facilitate more timely design, implementation, and deployment of 5G/NR solutions. Furthermore, such embodiments can facilitate flexible and timely control of data session QoS, which can lead to improvements in capacity, throughput, latency, etc. that are envisioned by 5G/NR and important for the growth of OTT services.

A measurement procedure can be provided for the purpose of monitoring data rate, latency and other network operational aspects on which the one or more embodiments improve. There can further be an optional network functionality for reconfiguring OTT connection 1450 between host computer 1410 and UE 1430, in response to variations in the measurement results. The measurement procedure and/or the network functionality for reconfiguring OTT connection 1450 can be implemented in software 1411 and hardware 1415 of host computer 1410 or in software 1431 and hardware 1435 of UE 1430, or both. In embodiments, sensors (not shown) can be deployed in or in association with communication devices through which OTT connection 1450 passes; the sensors can participate in the measurement procedure by supplying values of the monitored quantities exemplified above or by supplying values of other physical quantities from which software 1411, 1431 can compute or estimate the monitored quantities. The reconfiguring of OTT connection 1450 can include message format, retransmission settings, preferred routing etc.; the reconfiguring need not affect base station 1420, and it can be unknown or imperceptible to base station 1420. Such procedures and functionalities can be known and practiced in the art. In certain embodiments, measurements can involve proprietary UE signaling facilitating host computer 1410's measurements of throughput, propagation times, latency and the like. The measurements can be implemented in that software 1411 and 1431 causes messages to be transmitted, in particular empty or ‘dummy’ messages, using OTT connection 1450 while it monitors propagation times, errors, etc.

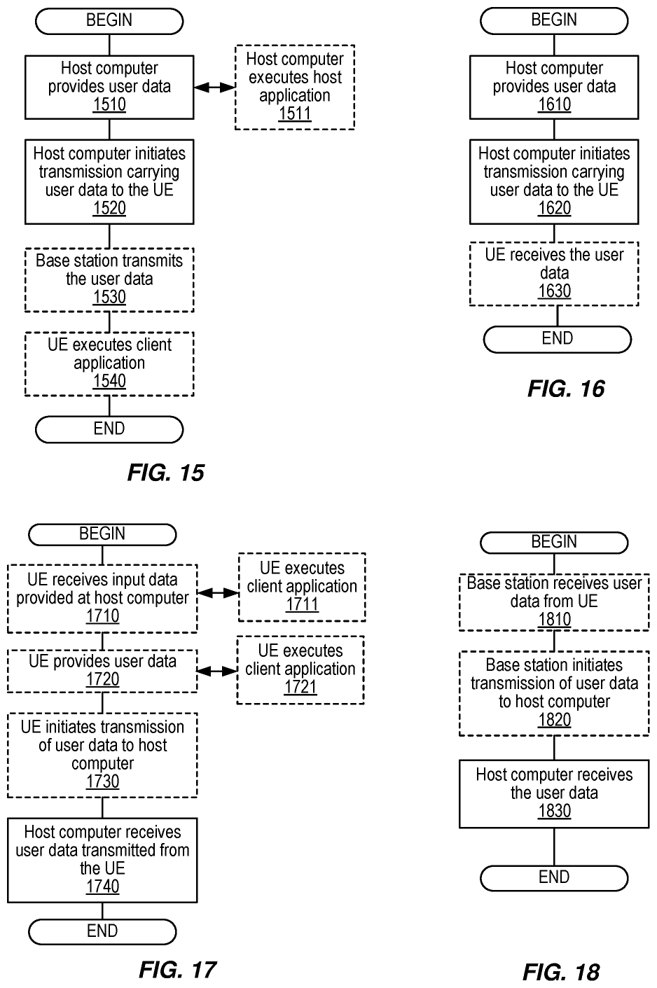

FIG. 15 is a flowchart illustrating an exemplary method and/or procedure implemented in a communication system, in accordance with one embodiment. The communication system includes a host computer, a base station and a UE which, in some embodiments, can be those described with reference to other figures herein. For simplicity of the present disclosure, only drawing references to FIG. 15 will be included in this section. In step 1510, the host computer provides user data. In substep 1511 (which can be optional) of step 1510, the host computer provides the user data by executing a host application. In step 1520, the host computer initiates a transmission carrying the user data to the UE. In step 1530 (which can be optional), the base station transmits to the UE the user data which was carried in the transmission that the host computer initiated, in accordance with the teachings of the embodiments described throughout this disclosure. In step 1540 (which can also be optional), the UE executes a client application associated with the host application executed by the host computer.

FIG. 16 is a flowchart illustrating an exemplary method and/or procedure implemented in a communication system, in accordance with one embodiment. The communication system includes a host computer, a base station and a UE which can be those described with reference to other figures herein. For simplicity of the present disclosure, only drawing references to FIG. 16 will be included in this section. In step 1610 of the method, the host computer provides user data. In an optional sub step (not shown) the host computer provides the user data by executing a host application. In step 1620, the host computer initiates a transmission carrying the user data to the UE. The transmission can pass via the base station, in accordance with the teachings of the embodiments described throughout this disclosure. In step 1630 (which can be optional), the UE receives the user data carried in the transmission.

FIG. 17 is a flowchart illustrating an exemplary method and/or procedure implemented in a communication system, in accordance with one embodiment. The communication system includes a host computer, a base station and a UE which can be those described with reference to other figures herein. For simplicity of the present disclosure, only drawing references to FIG. 17 will be included in this section. In step 1710 (which can be optional), the UE receives input data provided by the host computer. Additionally or alternatively, in step 1720, the UE provides user data. In substep 1721 (which can be optional) of step 1720, the UE provides the user data by executing a client application. In substep 1711 (which can be optional) of step 1710, the UE executes a client application which provides the user data in reaction to the received input data provided by the host computer. In providing the user data, the executed client application can further consider user input received from the user. Regardless of the specific manner in which the user data was provided, the UE initiates, in substep 1730 (which can be optional), transmission of the user data to the host computer. In step 1740 of the method, the host computer receives the user data transmitted from the UE, in accordance with the teachings of the embodiments described throughout this disclosure.

FIG. 18 is a flowchart illustrating an exemplary method and/or procedure implemented in a communication system, in accordance with one embodiment. The communication system includes a host computer, a base station and a UE which can be those described with reference to other figures herein. For simplicity of the present disclosure, only drawing references to FIG. 18 will be included in this section. In step 1810 (which can be optional), in accordance with the teachings of the embodiments described throughout this disclosure, the base station receives user data from the UE. In step 1820 (which can be optional), the base station initiates transmission of the received user data to the host computer. In step 1830 (which can be optional), the host computer receives the user data carried in the transmission initiated by the base station.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the spirit and scope of the disclosure. Various embodiments can be used together with one another, as well as interchangeably therewith, as should be understood by those having ordinary skill in the art.

The term unit, as used herein, can have conventional meaning in the field of electronics, electrical devices and/or electronic devices and can include, for example, electrical and/or electronic circuitry, devices, modules, processors, memories, logic solid state and/or discrete devices, computer programs or instructions for carrying out respective tasks, procedures, computations, outputs, and/or displaying functions, etc., such as those that are described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

As described herein, device and/or apparatus can be represented by a semiconductor chip, a chipset, or a (hardware) module comprising such chip or chipset; this, however, does not exclude the possibility that a functionality of a device or apparatus, instead of being hardware implemented, be implemented as a software module such as a computer program or a computer program product comprising executable software code portions for execution or being run on a processor. Furthermore, functionality of a device or apparatus can be implemented by any combination of hardware and software. A device or apparatus can also be regarded as an assembly of multiple devices and/or apparatuses, whether functionally in cooperation with or independently of each other. Moreover, devices and apparatuses can be implemented in a distributed fashion throughout a system, so long as the functionality of the device or apparatus is preserved. Such and similar principles are considered as known to a skilled person.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In addition, certain terms used in the present disclosure, including the specification and drawings, can be used synonymously in certain instances (e.g., “data” and “information”). It should be understood, that although these terms (and/or other terms that can be synonymous to one another) can be used synonymously herein, there can be instances when such words can be intended to not be used synonymously. Further, to the extent that the prior art knowledge has not been explicitly incorporated by reference herein above, it is explicitly incorporated herein in its entirety. All publications referenced are incorporated herein by reference in their entireties.

Embodiments of the techniques and apparatus described herein also include, but are not limited to, the following enumerated examples:

A1. A method for a user equipment (UE) to obtain security credentials for accessing a non-public network (NPN), the method comprising:
performing a primary authentication procedure to obtain a key, K_{AUSF}, for secure communication between the UE and an onboarding network (ON);
receiving, from a unified data management (UDM) function, encrypted UE credentials for accessing the NPN; and
decrypting the encrypted UE credentials based on K_{AUSF}.
   A2. The method of embodiment A1, wherein one of the following cryptographic algorithms or functions is used to decrypt the encrypted UE credentials:
a hash message authentication code (HMAC) function; or
a particular cryptographic algorithm used for protection of UE Parameter Update (UPU) procedure payloads.
   A3. The method of any of embodiments A1-A2, wherein one of the following keys is used to decrypt the UE credentials:
K_{AUSF}; or
a key derived from K_{AUSF} based on a Generic Bootstrapping Architecture (GBA) Key Derivation Function (KDF) and a specific FC value allocated for UPU key derivation.
   A4. The method of any of embodiments A1-A3, wherein the encrypted UE credentials are received in control plane (CP) non-access stratum (NAS) signaling from an access and mobility management function (AMF) associated with the NPN.
   A5. The method of any of embodiments A1-A4, wherein the UDM function is part of a provisioning server (PS) for the NPN.
   A6. The method of any of embodiments A1-A5, wherein the primary authentication is based on default UE credentials.
   A7. The method of any of embodiments A1-A6, further comprising obtaining access to the NPN based on the decrypted UE credentials.
   B1. A method for an authentication server function (AUSF) to facilitate user equipment (UE) access to a non-public network (NPN), the method comprising:
performing a primary authentication procedure to obtain a key, K_{AUSF}, for secure communication between the UE and an onboarding network (ON);
receiving, from a unified data management function (UDM), unencrypted UE credentials for the UE to access the NPN;
encrypting the UE credentials based on K_{AUSF}; and
sending the encrypted UE credentials to the UDM.
   B2. The method of embodiment B1, wherein one of the following cryptographic algorithms or functions is used to encrypt the UE credentials:
a hash message authentication code (HMAC) function; or
a particular cryptographic algorithm used for protection of UE Parameter Update (UPU) procedure payloads.
   B3. The method of any of embodiments B1-B2, wherein one of the following keys is used to encrypt the UE credentials:

K_{AUSF}; or
a key derived from K_{AUSF} based on a Generic Bootstrapping Architecture (GBA) Key Derivation Function (KDF) and a specific FC value allocated for UPU key derivation.
   B4. The method of any of embodiments B1-B3, wherein the UDM function is part of a provisioning server (PS) for the NPN.
   B5. The method of any of embodiments B1-B3, wherein:
the AUSF is part of the ON; and
a trust relationship exists between the AUSF and a provisioning server (PS) for the NPN before receiving the unencrypted UE credentials.
   B6. The method of any of embodiments B1-B5, wherein the primary authentication is based on default UE credentials obtained by the AUSF from a default credential server (DCS).
   C1. A method, by a unified data management function (UDM), for facilitating user equipment (UE) access to a non-public network (NPN), the method comprising:
obtaining encrypted UE credentials for the UE to access the NPN, from one of the following:
   a provisioning server (PS) for the NPN, or
   an authentication server function (AUSF); and
sending the encrypted UE credentials to the UE.
   C2. The method of embodiment C1, wherein obtaining the encrypted UE credentials comprises:
sending unencrypted UE credentials to the AUSF; and
receiving the encrypted UE credentials from the AUSF.
   C3. The method of embodiment C2, wherein:
the UDM is part of an onboarding network (ON); and
obtaining the encrypted UE credentials further comprises receiving the unencrypted UE credentials from a provisioning server (PS) for the NPN.
   C4. The method of embodiment C3, wherein a trust relationship exists between the UDM and the PS before receiving the unencrypted UE credentials.
   C5. The method of embodiment C2, wherein the UDM is part of a provisioning server (PS) for the NPN.
   C6. The method of any of embodiments C1-C5, wherein one of the following cryptographic algorithms or functions is used to encrypt the UE credentials:
a hash message authentication code (HMAC) function; or
a particular cryptographic algorithm used for protection of UE Parameter Update (UPU) procedure payloads.
   C7. The method of any of embodiments C1-C6, wherein one of the following keys is used to encrypt the UE credentials:
K_{AUSF}; or
a key derived from K_{AUSF} based on a Generic Bootstrapping Architecture (GBA) Key Derivation Function (KDF) and a specific FC value allocated for UPU key derivation.
   C8. The method of any of embodiments C1-C7, wherein the encrypted UE credentials are sent to the UE via an access and mobility management function (AMF) associated with the NPN.
   D1. A method, by a provisioning server (PS) for a non-public network (NPN), to facilitate user equipment (UE) access to the NPN, the method comprising:
obtaining encrypted UE credentials for the UE to access the NPN; and
sending the encrypted UE credentials to the UE.
   D2. The method of embodiment D1, wherein:
the PS includes a unified data management function (UDM); and
obtaining the encrypted UE credentials comprises the following operations by the UDM:
   sending unencrypted UE credentials to an authentication server function (AUSF); and
   receiving the encrypted UE credentials from the AUSF.
      D3. The method of embodiment D2, wherein:
the AUSF is part of an onboarding network (ON); and
a trust relationship exists between the AUSF and the PS before sending the unencrypted UE credentials.
   D4. The method of any of embodiments D2-D3, wherein one of the following keys is used to encrypt the UE credentials:
K_{AUSF}; or
a key derived from K_{AUSF} based on a Generic Bootstrapping Architecture (GBA) Key Derivation Function (KDF) and a specific FC value allocated for UPU key derivation.
   D5. The method of any of embodiments D2-D4, wherein the encrypted UE credentials are sent to the UE via an access and mobility management function (AMF) associated with the NPN.
   D6. The method of embodiment D1, wherein obtaining the encrypted UE credentials comprises:
receiving, from an authentication server function (AUSF) of an onboarding network (ON), a key (K_{PS}) derived from a key (K_{AUSF}) used for secure communication between the UE and the ON; and
encrypting the unencrypted UE credentials using the derived key (K_{PS}).
   D7. The method of embodiment D6, wherein the encrypted UE credentials are sent to the UE via a unified data management function (UDM) and an access and mobility management function (AMF) associated with the NPN.
   D8. The method of any of embodiments D1-D7, wherein one of the following cryptographic algorithms or functions is used to encrypt the UE credentials:
a hash message authentication code (HMAC) function; or
a particular cryptographic algorithm used for protection of UE Parameter Update (UPU) procedure payloads.
   E1. A user equipment (UE) configured to obtain security credentials for accessing a non-public network (NPN), the UE comprising:
radio interface circuitry configured to communicate with an access and mobility management function (AMF) associated with the NPN; and
processing circuitry operably coupled to the radio interface circuitry, whereby the processing circuitry and radio interface circuitry are configured to perform operations corresponding to any of the methods of embodiments A1-A7.
   E2. A user equipment (UE) configured to obtain security credentials for accessing a non-public network (NPN), the UE being further configured to perform operations corresponding to any of the methods of embodiments A1-A7.
   E3. A non-transitory, computer-readable medium storing computer-executable instructions that, when executed by processing circuitry of a user equipment (UE) configured to obtain security credentials for accessing a non-public network (NPN), configure the UE to perform operations corresponding to any of the methods of embodiments A1-A7.
   E4. A computer program product comprising computer-executable instructions that, when executed by processing circuitry of a user equipment (UE) configured to obtain security credentials for accessing a non-public network (NPN), configure the UE to perform operations corresponding to any of the methods of embodiments A1-A7.
   F1. An authentication server function (AUSF) configured to facilitate user equipment (UE) access to a non-public network (NPN), the AUSF comprising:
interface circuitry configured to communicate with a unified data management function (UDM); and
processing circuitry operably coupled to the interface circuitry, whereby the processing circuitry and interface circuitry are configured to perform operations corresponding to any of the methods of embodiments B1-B6.
   F2. An authentication server function (AUSF) configured to facilitate user equipment (UE) access to a non-public network (NPN), the AUSF being further configured to perform operations corresponding to any of the methods of embodiments B1-B6.
   F3. A non-transitory, computer-readable medium storing computer-executable instructions that, when executed by processing circuitry associated with an authentication server function (AUSF) configured to facilitate user equipment (UE) access to a non-public network (NPN), configure the AUSF to perform operations corresponding to any of the methods of embodiments B1-B6.
   F4. A computer program product comprising computer-executable instructions that, when executed by processing circuitry associated with an authentication server function (AUSF) configured to facilitate user equipment (UE) access to a non-public network (NPN), configure the AUSF to perform operations corresponding to any of the methods of embodiments B1-B6.
   G1. A unified data management function (UDM) configured to facilitate user equipment (UE) access to a non-public network (NPN), the UDM comprising:
interface circuitry configured to communicate with:
   the UE via an access and mobility management function (AMF) associated with the NPN,
   a provisioning server (PS) for the NPN, and
   an authentication server function (AUSF); and
processing circuitry operably coupled to the interface circuitry, whereby the processing circuitry and interface circuitry are configured to perform operations corresponding to any of the methods of embodiments C1-C8.
   G2. A unified data management function (UDM) configured to facilitate user equipment (UE) access to a non-public network (NPN), the UDM being configured to perform operations corresponding to any of the methods of embodiments C1-C8.
   G3. A non-transitory, computer-readable medium storing computer-executable instructions that, when executed by processing circuitry associated with a unified data management function (UDM) configured to facilitate user equipment (UE) access to a non-public network (NPN), configure the UDM to perform operations corresponding to any of the methods of embodiments C1-C8.
   G4. A computer program product comprising computer-executable instructions that, when executed by processing circuitry associated with a unified data management function (UDM) configured to facilitate user equipment (UE) access to a non-public network (NPN), configure the UDM to perform operations corresponding to any of the methods of embodiments C1-C8.
   H1. A provisioning server (PS) configured to facilitate user equipment (UE) access to a non-public network (NPN), the PS comprising:
interface circuitry configured to communicate with the UE via at least one of:
   an access and mobility management function (AMF) associated with the NPN, and
   an authentication server function (AUSF); and
processing circuitry operably coupled to the interface circuitry, whereby the processing circuitry and interface circuitry are configured to perform operations corresponding to any of the methods of embodiments D1-D7.
   H2. A provisioning server (PS) configured to facilitate user equipment (UE) access to a non-public network (NPN), the PS being further configured to perform operations corresponding to any of the methods of embodiments D1-D7.
   H3. A non-transitory, computer-readable medium storing computer-executable instructions that, when executed by processing circuitry associated with a provisioning server (PS) configured to facilitate user equipment (UE) access to a non-public network (NPN), configure the PS to perform operations corresponding to any of the methods of embodiments D1-D7.
   H4. A computer program product comprising computer-executable instructions that, when executed by processing circuitry associated with a provisioning server (PS) configured to facilitate user equipment (UE) access to a non-public network (NPN), configure the PS to perform operations corresponding to any of the methods of embodiments D1-D7.

1.-50. (canceled)

51. A method for a user equipment (UE) to obtain security credentials for accessing a non-public network (NPN), the method comprising:
performing a primary authentication procedure to obtain a key K_{AUSF} for secure communication between the UE and an onboarding network (ON);
receiving, from a unified data management (UDM) function, encrypted UE credentials for accessing the NPN; and
decrypting the encrypted UE credentials based on K_{AUSF}.

52. The method of claim 51, wherein one of the following cryptographic algorithms or functions is used to decrypt the encrypted UE credentials:
a hash message authentication code (HMAC) function; or
a cryptographic algorithm used for protection of UE Parameter Update (UPU) procedure payloads.

53. The method of claim 51, wherein one of the following keys is used to decrypt the UE credentials:
K_{AUSF}; or
a key derived from K_{AUSF} based on a Generic Bootstrapping Architecture (GBA), Key Derivation Function (KDF), and a specific FC value allocated for UPU key derivation.

54. The method of claim 51, wherein the encrypted UE credentials are received in control plane (CP) non-access stratum (NAS) signaling from an access and mobility management function (AMF) associated with the NPN.

55. The method of claim 51, wherein the primary authentication procedure is based on default UE credentials.

56. The method of claim 51, further comprising obtaining access to the NPN based on the decrypted UE credentials.

57. A method for an authentication server function (AUSF) to facilitate user equipment (UE) access to a non-public network (NPN), the method comprising:
performing a primary authentication procedure to obtain a key K_{AUSF} for secure communication between the UE and an onboarding network (ON);
receiving, from a unified data management (UDM) function, unencrypted UE credentials for the UE to access the NPN;
encrypting the UE credentials based on K_{AUSF}; and
sending the encrypted UE credentials to the UDM function.

58. A user equipment (UE) configured to obtain security credentials for accessing a non-public network (NPN), the UE comprising:
communication interface circuitry configured to communicate with an access and mobility management function (AMF) associated with the NPN; and
processing circuitry operably coupled to the communication interface circuitry, whereby the processing circuitry and communication interface circuitry are configured to:
perform a primary authentication procedure to obtain a key K_{AUSF} for secure communication between the UE and an onboarding network (ON);
receive, from a unified data management (UDM) function, encrypted UE credentials for accessing the NPN; and
decrypt the encrypted UE credentials based on K_{AUSF}.

59. The UE of claim 58, wherein the processing circuitry and the communication interface circuitry are configured to decrypt the encrypted UE credentials by using one of the following cryptographic algorithms or functions:
a hash message authentication code (HMAC) function; or
a cryptographic algorithm used for protection of UE Parameter Update (UPU) procedure payloads.

60. The UE of claim 58, wherein the processing circuitry and the communication interface circuitry are configured to use one of the following keys to decrypt the UE credentials:
K_{AUSF}; or
a key derived from K_{AUSF} based on a Generic Bootstrapping Architecture (GBA), Key Derivation Function (KDF), and a specific FC value allocated for UPU key derivation.

61. The UE of claim 58, wherein the processing circuitry and the communication interface circuitry are configured to receive the encrypted UE credentials in control plane (CP) non-access stratum (NAS) signaling from the AMF associated with the NPN.

62. The UE of claim 58, wherein the primary authentication procedure is based on default UE credentials.

63. The UE of claim 58, wherein the processing circuitry and the communication interface circuitry are configured to obtain access to the NPN based on the decrypted UE credentials.

64. A non-transitory, computer-readable medium storing computer-executable instructions that, when executed by processing circuitry of a user equipment (UE) configured to obtain security credentials for accessing a non-public network (NPN), configure the UE to perform operations corresponding to the method of claim 51.
